(19) United States
(12) Patent Application Publication
(10) Pub. No.: US 2022/0067351 A1
(43) Pub. Date: Mar. 3, 2022

(54) DICTIONARY CREATION DEVICE, BIOMETRICS DEVICE, MONITORING SYSTEM, DICTIONARY CREATION METHOD, AND RECORDING MEDIUM

(71) Applicant: NEC Corporation, Minato-ku, Tokyo (JP)

(72) Inventor: Toshiyuki SASHIHARA, Tokyo (JP)

(73) Assignee: NEC Corporation, Minato-ku, Tokyo (JP)

(21) Appl. No.: 17/419,049

(22) PCT Filed: Mar. 1, 2019
(86) PCT No.: PCT/JP2019/008071

§ 371 Date: Jun. 28, 2021

(51) Int. Cl. G06K 9/00; G06F 21/32; G06T 7/00

(52) U.S. Cl. CPC G06K 9/00295; G06F 21/32; G06F 2221/2141; G06T 2207/30201; G06T 7/97

(57) ABSTRACT

Provided is a dictionary creation device capable of easily generating a dictionary that stores information regarding persons permitted to enter a monitoring area. An image acquisition unit (31) acquires a plurality of images captured at intervals within a predetermined area, a feature extraction unit (32) extracts a feature of a person included in each of the plurality of images, a similarity calculation unit (33) calculates a similarity between the feature of a first person included in one image of the plurality of images and the feature of a second person included in another image or a plurality of other images, and a registration unit (34) determines whether to register information regarding the first person in a dictionary based on the similarity.

### TECHNICAL FIELD

The present invention relates to a dictionary creation device, a biometrics device, a monitoring system, a dictionary creation method, and a recording medium, and relates to, for example, a dictionary creation device that generates a person dictionary used for biometrics, and the like.

### BACKGROUND ART

Many people frequently visit cram schools, schools, and other facilities. Therefore, it is difficult to find a suspicious person who is trying to enter these facilities. A related technique registers face images of people permitted to enter these facilities in a dictionary (also called whitelist). Then, in a case where a person who is not registered in the dictionary is found by a monitoring camera installed at a key point such as an entrance of a facility, an alarm is issued or a danger is notified to persons concerned.

PTL 1 discloses a method of registering information regarding a person without intervention of an authorized person by causing a person to present a password or a barcode.

### CITATION LIST

### Patent Literature

### [PTL 1] JP 2009-205393 A

### [PTL 2] JP 2004-157602 A

### SUMMARY OF INVENTION

### Technical Problem

The technique disclosed in PTL 1 requires a great deal of time and labor to manually register information regarding a large number of persons in a dictionary. In particular, students who go to cram schools and schools change frequently due to entrance, transfer, graduation, and the like, so that it takes a lot of time and effort to generate a dictionary.

An object of the present invention is to provide a dictionary creation device capable of easily generating a dictionary that stores information regarding persons permitted to enter a monitoring area, and the like.

### Solution to Problem

A dictionary creation device according to one aspect of the present invention includes an image acquisition means for acquiring a plurality of images captured at intervals within a predetermined area, a feature extraction means for extracting a feature of a person included in each of the plurality of images, a similarity calculation means for calculating a similarity between the feature of a first person included in one image of the plurality of images and the feature of a second person included in another image or a plurality of other images, and a registration means for determining whether to register information regarding the first person in a dictionary based on the similarity.

A dictionary creation method according to one aspect of the present invention includes acquiring a plurality of images captured at intervals within a predetermined area, extracting a feature of a person included in each of the plurality of images, calculating a similarity between the feature of a first person included in one image of the plurality of images and the feature of a second person included in another image or a plurality of other images, and determining whether to register information regarding the first person in a dictionary based on the similarity.

A recording medium according to one aspect of the present invention stores a program for causing a computer to execute acquiring a plurality of images captured at intervals within a predetermined area, extracting a feature of a person included in each of the plurality of images, calculating a similarity between the feature of a first person included in one image of the plurality of images and the feature of a second person included in another image or a plurality of other images, and determining whether to register information regarding the first person in a dictionary based on the similarity.

A monitoring system according to one aspect of the present invention includes a person detection means, a dictionary creation device, and a biometrics device, in which the person detection means detects a region of a person from a plurality of images captured at intervals within a predetermined area, the dictionary creation device includes an image acquisition means for acquiring the plurality of images including the region of the person from the person detection means, a feature extraction means for extracting a feature of the person included in each of the plurality of images, a similarity calculation means for calculating a similarity between the feature of a first person included in one image of the plurality of images and the feature of a second person included in another image or a plurality of other images, and a registration means for determining whether to register information regarding the first person in a dictionary based on the similarity, and the biometrics device includes a collation means for collating a person in the input image with the first person registered in the dictionary by referring to the dictionary generated by the dictionary creation device, and an output means for outputting a collation result by the collation means.

### Advantageous Effects of Invention

According to the present invention, a dictionary that stores information regarding persons permitted to enter a monitoring area can be easily generated.

### BRIEF DESCRIPTION OF DRAWINGS

FIG. 1 is a block diagram illustrating a configuration of a monitoring system according to a first example embodiment.

FIG. 2 is a flowchart illustrating a flow of processing executed by a person detection unit of the monitoring system according to the first example embodiment.

FIG. 3 is a diagram illustrating a monitoring camera included in the monitoring system according to the first example embodiment and a person in a field of view of the monitoring camera.

FIG. 4 is a block diagram illustrating a configuration of a dictionary creation device according to the first example embodiment.

FIG. 5 is a table illustrating a similarity between persons.

FIG. 6 is a flowchart illustrating a flow of processing executed by each unit of the dictionary creation device according to the first example embodiment.

FIG. 7 is a block diagram illustrating a configuration of a biometrics device according to the first example embodiment.

FIG. 8 is a flowchart illustrating a flow of processing executed by the biometrics device according to the first example embodiment.

FIG. 9 is a block diagram illustrating a configuration of a dictionary creation device according to a second example embodiment.

FIG. 10 is a flowchart illustrating a flow of processing executed by the dictionary creation device according to the second example embodiment.

FIG. 11 is a diagram illustrating persons detected by a person detection unit according to the second example embodiment in chronological order.

FIG. 12A is a bar graph illustrating detection counts of persons at a certain time.

FIG. 12B is a bar graph illustrating detection counts of persons at another time.

FIG. 12C is a bar graph illustrating detection counts of persons at still another time.

FIG. 13 is a block diagram illustrating a configuration of a dictionary creation device according to a third example embodiment.

FIG. 14 is a flowchart illustrating a flow of processing executed by the dictionary creation device according to the third example embodiment during a registration period.

FIG. 15 is a bar graph illustrating a cumulative similarity among persons.

FIG. 16 is a diagram illustrating a configuration of hardware device according to a fourth example embodiment.

### EXAMPLE EMBODIMENT

The directions of the arrows in the drawings are illustrative and do not limit the directions of signals between blocks.

### First Example Embodiment

Hereinafter, a first example embodiment of the present invention will be described.

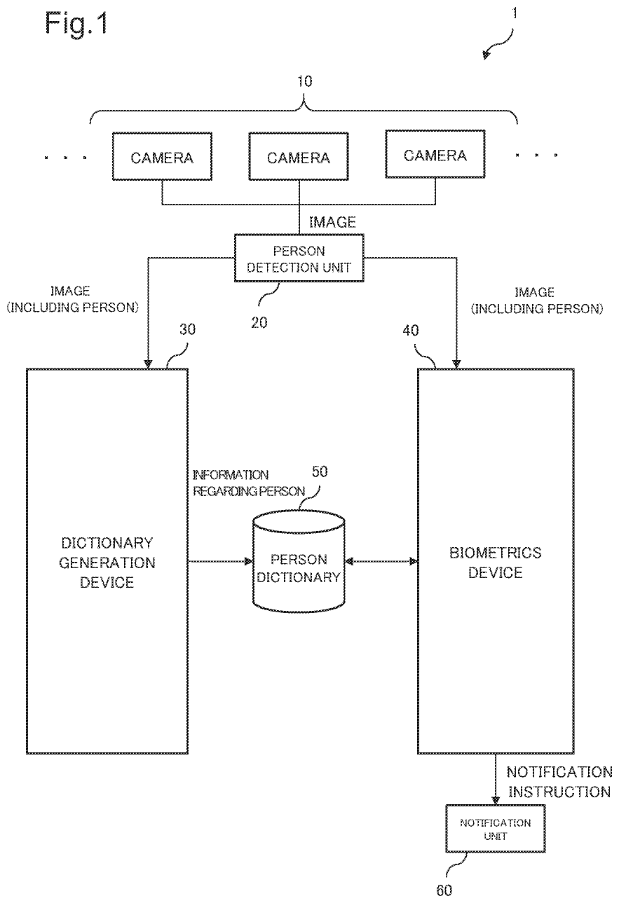

FIG. 1 is a block diagram illustrating a configuration of a monitoring system 1 according to the first example embodiment. The monitoring system 1 illustrated in FIG. 1 includes a plurality of cameras 10, a person detection unit 20, a dictionary creation device 30, a biometrics device 40, a person dictionary 50, and a notification unit 60. The monitoring system 1 may not include at least one of the cameras 10 or the notification unit 60. The monitoring system 1 finds a suspicious person by the plurality of cameras 10 arranged in a monitoring area such as the premises of a school and notifies a person concerned of danger by an alarm or the like. The number of cameras 10 may be one or more and is not particularly limited. Each camera 10 captures an object in a capture region with time-series images (a movie or a plurality of still images) at intervals of a predetermined time Δt (for example, 10 minutes).

The person detection unit 20 will be described. The person detection unit 20 is an example of a person detection means.

The person detection unit 20 acquires the time-series images (the movie or the plurality of still images) captured by the plurality of cameras 10 in real time and detects a region of a person from each of the acquired images. Specifically, the person detection unit 20 extracts an image region having a feature (for example, histogram of oriented gradients (HOG), scale-invariant feature transform (SIFT), or speeded-up robust features (SURF)) indicating personness from each of the acquired images. Hereinafter, the person detection unit 20 detecting the region of a person from each image will be referred to as the person detection unit 20 detecting the person. In a case where the monitoring system 1 does not include the cameras 10, the person detection unit 20 acquires the time-series images stored in a video recording apparatus (not illustrated), for example.

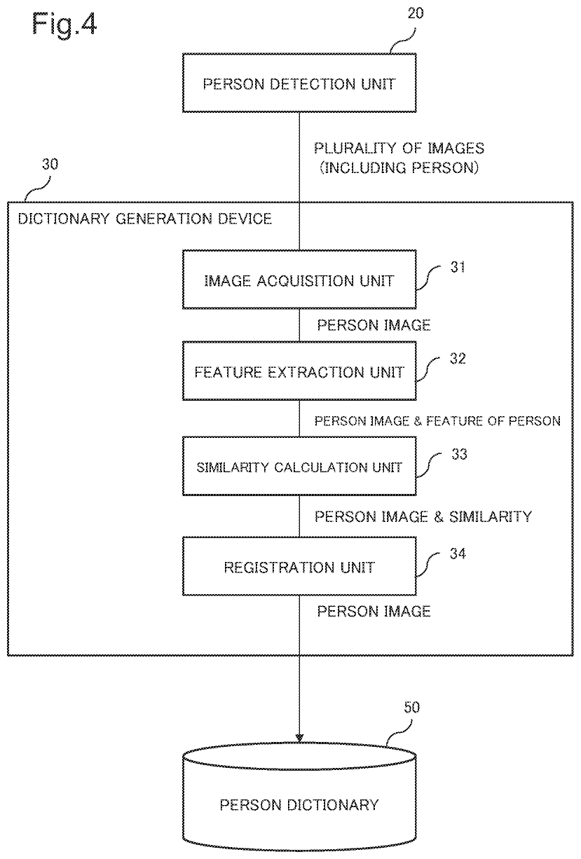

As will be described below with reference to FIG. 4, an image acquisition unit 31 of the dictionary creation device 30 receives the plurality of images captured at intervals within a predetermined area from the person detection unit 20. For example, the images acquired by the image acquisition unit 31 are captured at intervals of a predetermined time, at the same time on the same day, or in accordance with a predetermined trigger. Each image transmitted from the person detection unit 20 includes a person. The image acquisition unit 31 generates a plurality of person images from the plurality of received images and transmits the plurality of person images to a feature extraction unit 32. The person image is an image including a region of one person. The person image may be the image itself received by the image acquisition unit 31 from the person detection unit 20 or may be a part of the image. The person image may include only a part of a person (for example, the face or a pupil).

The feature extraction unit 32 extracts a feature of a person included in each of the plurality of person images. For example, the feature extraction unit 32 extracts information indicating a feature related to the face or a pupil of the person from a region of the face or the pupil of the person included in the person image.

A registration unit 34 of the dictionary creation device 30 registers information regarding a person who is permitted to enter the monitoring area in the person dictionary 50 after predetermined processing, which will be described below. In the first example embodiment, the registration unit 34 registers the person image including the region of the person as the information regarding a person in the person dictionary 50. The person image may include only a part (for example, the face) of the person. Furthermore, the registration unit 34 may also register the feature of the person extracted by the feature extraction unit 32 in the person dictionary 50.

Alternatively, in a case where the feature extraction unit 32 extracts an iris pattern as the feature of the person, the registration unit 34 may register an image including the pupil of the person as the information regarding the person in the person dictionary 50.

Furthermore, the registration unit 34 may register the iris pattern extracted by the feature extraction unit 32 as the information regarding a person in the person dictionary 50. However, the information registered in the person dictionary 50 by the registration unit 34 is not limited to the examples.

A detailed configuration of the dictionary creation device 30 will be described below.

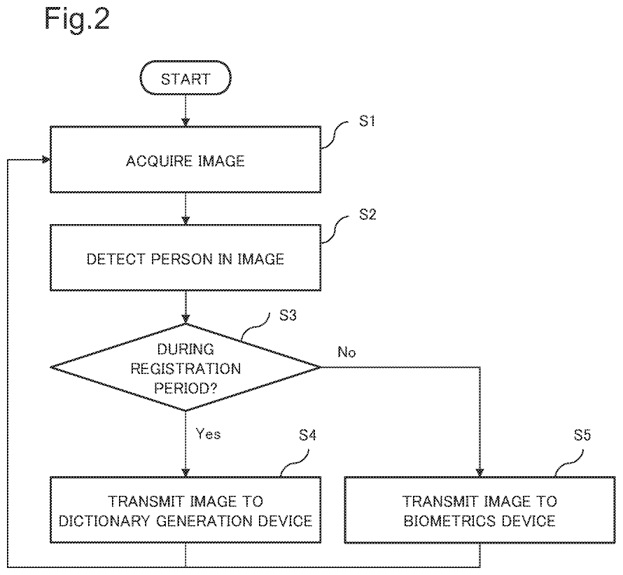

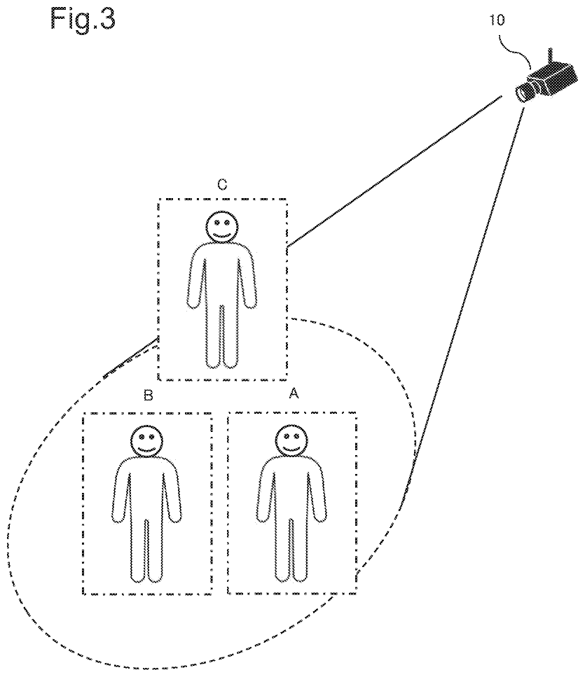

The operation of the person detection unit 20 will be described. A flow of processing executed by the person detection unit 20 according to the present example embodiment will be described with reference to FIGS. 2 and 3. FIG. 2 is a flowchart illustrating a flow of processing executed by the person detection unit 20. FIG. 3 illustrates persons A to C in a field of view of the camera 10 at certain time t1 during a registration period. The registration period is a period in which the dictionary creation device 30 registers the information regarding a person (for example, the person image including the region of the person and/or the feature of the person) in the person dictionary 50.

As illustrated in FIG. 2, the person detection unit 20 acquires an image p1 captured by the camera 10 at the time t1 (S1).

Next, the person detection unit 20 detects persons A to C in the image p1 (S2). Specifically, the person detection unit 20 detects a region including the persons A to C (or may be referred to as a region of the persons) from the image p1 in accordance with features indicating personness. In a case where the person detection unit 20 has not been able to detect a person from the image p1, the person detection unit 20 waits until the next image is acquired from the camera 10.

After step S2 illustrated in FIG. 2, the person detection unit 20 determines whether the present time is during the registration period (S3). For example, the person detection unit 20 determines whether the present time is during the registration period using a timer. When the current time has entered the registration period, the person detection unit 20 transmits a start signal to the dictionary creation device 30. When having received the start signal, the dictionary creation device 30 returns from the standby state. Furthermore, when the registration period ends, the person detection unit 20 transmits an end signal to the dictionary creation device 30. When having received the end signal, the dictionary creation device 30 transitions to the standby state.

The registration period may be freely set and changed. The registration period may include a period of suspension (interval) or may be interrupted at the discretion of an administrator or a person concerned. Furthermore, the registration period may be determined for each camera 10 that is a transmission source of the image. Alternatively, the registration period needs not be present. In a case where there is no registration period, step S3 of FIG. 2 is omitted, and processing in steps S4 and S5 illustrated in FIG. 2 is executed. The order of the processing in steps S4 and S5 is not limited.

In a case where the present time is during the registration period (Yes in S3), the person detection unit 20 transmits the image p1 including the persons A to C to the dictionary creation device 30 (S4). On the other hand, in a case where the present time is not during the registration period (No in S3), the person detection unit 20 transmits the image p1 including the persons A to C to the biometrics device 40 (S5).

After step S4 or step S5 illustrated in FIG. 2, the flow returns to step S1. Then, the person detection unit 20 acquires another image captured at time t2 (>t1) during the registration period from the camera 10. In this manner, the person detection unit 20 sequentially acquires the time-series images captured by the camera 10, and repeats the processing of detecting a person from each image. The period of time from the time t1 to the time t2, that is, a cycle in which the processing of steps S1 to S5 is repeated (corresponding to the above time interval Δt) is, for example, 10 minutes. This cycle is favorably set to be sufficiently long according to a use environment of the monitoring system 1. If the cycle is too short, the person in the field of view of the camera 10 does not move, so that the person detection unit 20 continuously detects the same person.

In the monitoring system 1, the camera 10 that captures the image to be transmitted to the dictionary creation device 30 and the camera 10 that captures the image to be transmitted to the biometrics device 40 may be different. In this case, the person detection unit 20 discriminates which camera 10 is the transmission source of the image.

Next, the dictionary creation device 30 will be described.

The dictionary creation device 30 according to the first example embodiment registers the person image related to the person permitted to enter the monitoring area in the person dictionary 50 during the registration period.

FIG. 4 is a block diagram for describing a configuration of the dictionary creation device 30 according to the first example embodiment. Specifically, FIG. 4 illustrates the dictionary creation device 30, the person detection unit 20, and the person dictionary 50 as a part of the configuration of FIG. 1. Furthermore, FIG. 4 illustrates a detailed configuration of the dictionary creation device 30. As illustrated in FIG. 4, the dictionary creation device 30 includes the image acquisition unit 31, the feature extraction unit 32, a similarity calculation unit 33, and the registration unit 34.

The image acquisition unit 31 is an example of an image acquisition means. The feature extraction unit 32 is an example of a feature extraction means. The similarity calculation unit 33 is an example of a similarity calculation means. The registration unit 34 is an example of a registration means.

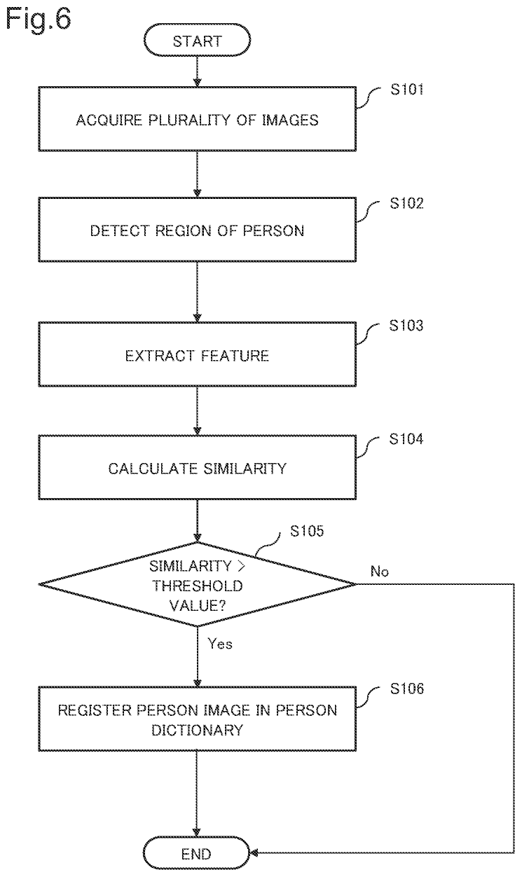

The image acquisition unit 31 acquires a plurality of images captured at intervals within a predetermined area from the person detection unit 20. These images correspond to the time-series images captured by the camera 10. Each image acquired by the image acquisition unit 31 includes a person. Here, the image acquisition unit 31 receives seven images including persons A to G during the registration period. The persons A to G are assumed to be included in the different images. The image acquisition unit 31 detects regions of the persons A to G from the plurality of received images, and generates a plurality of person images each corresponding to the persons A to G. The plurality of person images is images each including the regions of the persons A to G. The generation of the person images will be described below with reference to the flowchart of FIG. 6. The image acquisition unit 31 transmits the plurality of generated person images to the feature extraction unit 32.

The feature extraction unit 32 receives the plurality of person images from the image acquisition unit 31. Furthermore, the feature extraction unit 32 extracts features (for example, HOG) of the persons A to G from each of the plurality of person images. The feature extraction unit 32 generates data in which the features of the persons A to G extracted from the person images are associated with the received person images. The feature extraction unit 32 transmits the generated data to the similarity calculation unit 33.

The similarity calculation unit 33 receives data including the plurality of person images and the features of the persons A to G associated with the respective person images from the feature extraction unit 32. The similarity calculation unit 33 calculates a similarity between the feature of a first person included in one image of the plurality of images and the feature of a second person included in another image or a plurality of other images (hereinafter the similarity is referred to as a similarity between persons or is simply referred to as a similarity).

In one example, the feature of a person is expressed by binary data, and the similarity calculation unit 33 calculates a Hamming distance between the features of persons and calculates the similarity based on the calculated Hamming distance. For example, the similarity calculation unit 33 normalizes the Hamming distance to a value from 0 to 1, and subtracts the normalized Hamming distance from 1 to calculate the similarity. Thus, the similarity takes a value from 0 to 1. The similarity approaches 1 as the Hamming distance between the features of persons is shorter, and the similarity approaches 0 as the Hamming distance is longer.

Specifically, the similarity calculation unit 33 selects a combination of two persons from among the plurality of persons A to G. The similarity calculation unit 33 then calculates the similarity between the selected two persons. For example, when the first person is the person A, the second person is one of the persons B to G. In this case, the similarity calculation unit 33 calculates the similarity between the person A and each of the persons B to G.

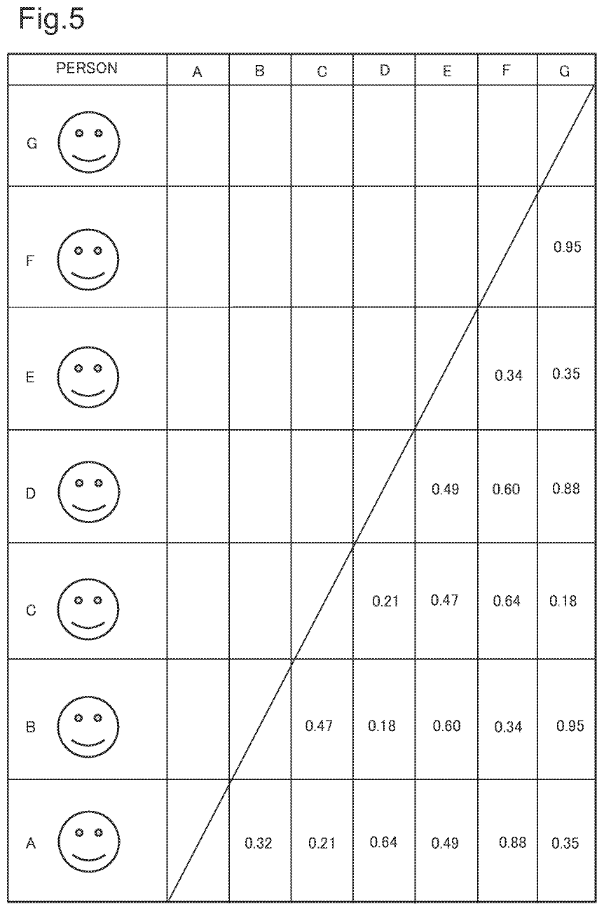

The table of FIG. 5 illustrates an example of the similarities among the persons A to G calculated as described above. The similarity is expressed as a numerical value from 0 to 1.00. In the table of FIG. 5, each of vertical columns and horizontal rows corresponds to one person. The similarity between the feature of one of the persons A to G illustrated in the vertical columns and the feature of one of the persons A to G illustrated in the horizontal rows is described in a frame where the column and the row intersect. For example, according to the table illustrated in FIG. 5, the similarity between the person A and the person B is 0.32.

The similarity calculation unit 33 transmits the plurality of person images corresponding to the persons A to G and calculation results of the similarities among the persons A to G to the registration unit 34.

The registration unit 34 is connected to the person dictionary 50. The registration unit 34 receives data including the plurality of person images corresponding to the persons A to G and the calculation results (see FIG. 5) of the similarities among the persons A to G from the similarity calculation unit 33. The registration unit 34 determines whether to register each piece of information regarding the persons A to G in the person dictionary 50 in accordance with the similarity calculated by the similarity calculation unit 33. Specifically, in a case where the similarity between the first person and the second person exceeds a threshold value, the registration unit 34 registers the information regarding the first person in the person dictionary 50. The threshold value may be optionally set.

For example, in the first example, the above-described threshold value is assumed to be 0.8. The similarity between the person A and the person F illustrated in FIG. 5 is 0.88. In this case, the registration unit 34 registers the information regarding the person A in the person dictionary 50. In the second example, the threshold value is assumed to be 0.90. All the similarities between the person A and the other persons B to G do not exceed the threshold value. In this case, the registration unit 34 does not register the information regarding the person A in the person dictionary 50.

The similarity between the first person and the second person being high means that there is a high possibility that the first person and the second person are the same person. That is, the same person is captured in the two person images. Therefore, the first person enters the monitoring area at least twice. The registration unit 34 registers only such information regarding the first person in the person dictionary 50. Meanwhile, it is assumed that a suspicious person enters the monitoring area only once and is captured by the camera 10. In this case, there is only one person image related to the suspicious person. As long as the dictionary creation device 30 can accurately identify the suspicious person from other persons, the registration unit 34 does not register information regarding the suspicious person in the person dictionary 50.

In this way, the dictionary creation device 30 discriminates the first person having entered the monitoring area at least twice as a person permitted to enter the monitoring area, and registers only such a first person in the person dictionary 50. Therefore, the person dictionary 50 that stores the information regarding persons permitted to enter the monitoring area can be easily generated.

Next, the person dictionary 50 will be described. As illustrated in FIG. 1, the person dictionary 50 is connected to the registration unit 34 of the dictionary creation device 30 and the biometrics device 40.

The person dictionary 50 stores the person image registered by the registration unit 34 of the dictionary creation device 30 as the information regarding a person. However, as will be described below, the person dictionary 50 may store the information regarding a person other than the person image. The monitoring system 1 may be configured such that an administrator or a person concerned can freely browse and edit the information regarding a person registered in the person dictionary 50.

A modification of the person dictionary 50 will be described.

In one modification, there may be a plurality of person dictionaries 50. For example, a different person dictionary 50 exists for each camera 10, for each area where the camera 10 is arranged, or for each time zone. In the present modification, the biometrics device 40 may combine the person dictionaries 50 used for biometrics in one or a plurality of areas and use the person dictionaries 50 for biometrics in another area.

According to the configuration of the present modification, for example, the biometrics device 40 can automatically permit a person to enter a third area (not illustrated), the person having been permitted to enter both a first area and a second area (not illustrated). Alternatively, the biometrics device 40 can automatically permit a person to enter the third area, the person having been permitted to enter at least one of the first area or the second area.

Next, the operation of the dictionary creation device 30 will be described.

Referring to FIG. 6, the operation of the dictionary creation device 30 will be described. FIG. 6 is a flowchart illustrating a flow of processing executed by each unit of the dictionary creation device 30 according to the first example embodiment.

As illustrated in FIG. 6, the image acquisition unit 31 acquires a plurality of images captured at intervals within a predetermined area from the person detection unit 20 (S101). Each image includes one or more persons.

The image acquisition unit 31 detects the region of a person from each of the plurality of acquired images. For example, the image acquisition unit 31 learns in advance features of parts of an unspecified person, such as the head, shoulders, arms, and legs, using a sample image of the unspecified person. Then, the image acquisition unit 31 detects a region having a feature similar to the learned features as the region of a person from each of the plurality of images (S102). Here, the region of a person may be a region of a whole body of one person or a region of a part of the body of the person. For example, the region of a person may be a region of the face of a person or a region of an eye or a pupil of the person. The image acquisition unit 31 may detect the region of a person from data indicating regions of persons.

The image acquisition unit 31 generates a plurality of person images from the plurality of images acquired from the person detection unit 20. Each person image includes the region of one person detected in step S102. The, the image acquisition unit 31 transmits the plurality of generated person images to the feature extraction unit 32. The data indicating the regions of persons may be added to the person images transmitted to the feature extraction unit 32. Furthermore, data of the person images may be stored in a storage device as the above-described sample images. Alternatively, the storage device may include the person dictionary 50.

The feature extraction unit 32 receives the plurality of person images from the image acquisition unit 31. The feature extraction unit 32 extracts the features of persons from the respective person images (S103). The feature extraction unit 32 transmits data in which the features of the persons extracted from the person images are associated with the person images including the regions of the persons to the similarity calculation unit 33. As described above, the feature extraction unit 32 may extract an iris pattern from the person image. In this case, the feature extraction unit 32 transmits data in which an image including an iris of the person (for example, a region of a pupil or an eye in the person image) is associated with the iris pattern of the person to the similarity calculation unit 33.

The similarity calculation unit 33 receives data including the plurality of person images and the persons extracted from the person images from the feature extraction unit 32. The similarity calculation unit 33 calculates similarities among the plurality of persons using the received data (S104).

In step S104, the similarity calculation unit 33 calculates the similarity between the first person and the second person based on the feature of the first person included in one image of the plurality of images and the feature of the second person included in another image or a plurality of other images. In a case where the iris patterns are received as the features of the persons from the feature extraction unit 32, the similarity calculation unit 33 calculates the similarity between the iris pattern of the first person and the iris pattern of one or a plurality of the second persons. The similarity calculation unit 33 transmits data including the plurality of person images and the calculation results of the similarities (see FIG. 5) to the registration unit 34.

The similarity is based on, for example, a well-known Hamming distance. As described above, the similarity calculation unit 33 normalizes the Hamming distance to a value from 0 to 1 and subtracts the normalized Hamming distance from 1 to calculate the similarity.

Alternatively, the similarity calculation unit 33 may calculate the similarity between the first person and the second person based on a distance and/or a direction between a feature vector regarding the first person and a feature vector regarding the second person. The feature vector is a multidimensional vector having a plurality of features as elements. In this case, the similarity calculation unit 33 also defines the similarity in such a manner that the similarity approaches 1 as the distance between the feature vectors becomes shorter or the directions are closer to each other, and the similarity approaches 0 as the distance between the feature vectors becomes longer or the directions are more distant from each other.

Alternatively, the similarity calculation unit 33 may calculate the similarity based on a correlation coefficient between the feature vector regarding the first person and the feature vector regarding the second person. In this case, the similarity calculation unit 33 defines the distance between the two feature vectors. Specifically, a value obtained by subtracting the correlation coefficient from 1 is defined as the distance (0 to 2) between the feature vectors so that the distance becomes larger as the correlation coefficient (−1 to 1) between the two feature vectors becomes larger. The similarity calculation unit 33 normalizes the distance (0 to 2) between the feature vectors to take a value from 0 to 1. Then, the similarity calculation unit 33 subtracts the normalized distance (0 to 1) from 1 to calculate the similarity that takes a value from 0 to 1. That is, the similarity becomes larger and approaches 1 as the normalized distance (0 to 1) becomes shorter.

The registration unit 34 receives the data including the plurality of person images and the calculation result of the similarity from the similarity calculation unit 33. The registration unit 34 determines information on which of the persons included in the plurality of person images is to be registered in the person dictionary 50 based on the similarity calculated by the similarity calculation unit 33.

Specifically, the registration unit 34 determines whether the similarity calculated by the similarity calculation unit 33 exceeds a certain threshold value (S105).

In a case where the similarity exceeds the certain threshold value (Yes in S105), the registration unit 34 registers the person image related to the first person in the person dictionary 50 (See FIG. 1) (S106).

The similarity between the first person and the second person being high means that there is a high possibility that the first person and the second person are the same person. Therefore, in other words, the registration unit 34 registers the first person in the person dictionary 50 in a case where there is a high possibility that the first person is included in at least two person images. The registration unit 34 may register an image including a region of a part (for example, the face or the pupil) of the first person in the person dictionary 50 as another information regarding the first person. Alternatively, the registration unit 34 may also register the feature of the first person in the person dictionary 50.

On the other hand, in a case where the similarity between the first person and the second person does not exceed the certain threshold value (No in S105), the registration unit 34 does not register the person image related to the first person in the person dictionary 50. Thus, the operation of the dictionary creation device 30 ends.

The dictionary creation device 30 may not generate a new person dictionary 50 for each registration period and overwrite or update the person dictionary 50 generated during the previous registration period. That is, the dictionary creation device 30 may register the person image related to the first person in the person dictionary 50 generated during the previous registration period.

According to the above configuration, the similarity calculation unit 33 calculates the similarity between the feature of the first person and the feature of one or a plurality of the second persons. The registration unit 34 can discriminate the first person from the second person based on the similarity. In a case where the similarity calculated by the similarity calculation unit 33 exceeds the threshold value, the registration unit 34 registers the person image related to the first person in the person dictionary 50.

With the above-described configuration, the dictionary creation device 30 can easily generate the person dictionary 50.

Next, the biometrics device 40 will be described. The biometrics device 40 authenticates a person, using the person dictionary 50 generated by the dictionary creation device 30. Hereinafter, a person registered in the person dictionary 50 is called registered person.

The configuration of the biometrics device 40 will be described.

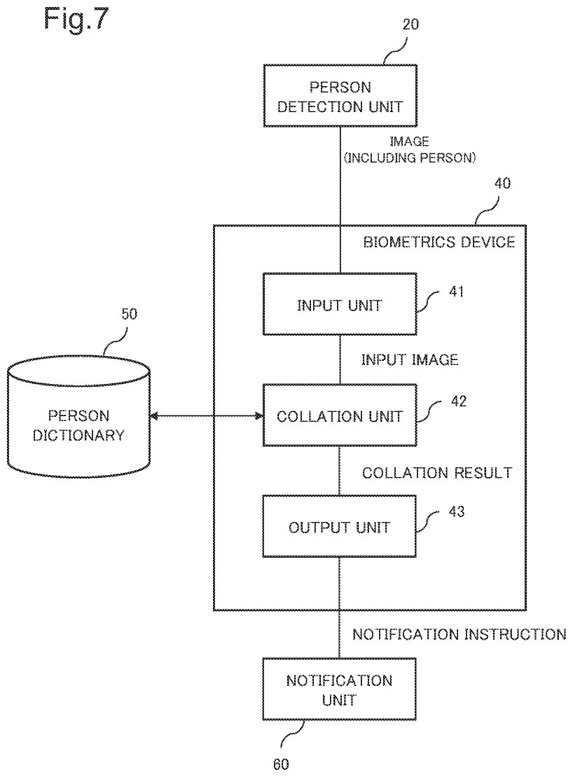

FIG. 7 is a block diagram for describing the configuration of the biometrics device 40. Specifically, FIG. 7 illustrates the biometrics device 40, the person detection unit 20, and the person dictionary 50 as a part of the configuration of FIG. 1. Furthermore, FIG. 7 illustrates a detailed configuration of the biometrics device 40. As illustrated in FIG. 7, the biometrics device 40 includes an input unit 41, a collation unit 42, and an output unit 43. The input unit 41 is an example of an input means. The collation unit 42 is an example of a collation means. The output unit 43 is an example of an output means.

The input unit 41 acquires an image (hereinafter referred to as an input image) from the person detection unit 20 (see FIG. 1) of the monitoring system 1. The input unit 41 transmits the acquired input image to the collation unit 42.

The collation unit 42 is connected to the person dictionary 50. The collation unit 42 receives the input image from the input unit 41. The collation unit 42 refers to the person dictionary 50 and collates a person in the input image acquired from the input unit 41 with the registered person registered in the person dictionary 50. Specifically, the collation unit 42 calculates the similarity between the person in the input image received from the input unit 41 and the registered person, using a general biometrics technique. For example, in the case where the person image related to the registered person is registered in the person dictionary 50 as the information regarding a person, the collation unit 42 extracts the feature from the person in the input image and extracts the feature of the registered person from the person image related to the registered person. Then, the collation unit 42 calculates the similarity between the feature of the person in the input image and the feature of the registered person.

The similarity is based on, for example, a well-known Hamming distance. Alternatively, two persons are assumed to be A and B. In this case, the collation unit 42 may calculate the similarity between the feature vector representing the feature of the person A and the feature vector representing the feature of the person B based on the distance and/or direction between the feature vectors. In this case, the feature vector is a multidimensional vector having a plurality of features as elements. Alternatively, the collation unit 42 may calculate the similarity based on the correlation coefficient between the feature vectors of the two persons.

Alternatively, in the case where the iris pattern of the registered person is registered in the person dictionary 50 as the information regarding a person, the collation unit 42 extracts an iris pattern from a pupil of the person in the input image. The collation unit 42 then calculates the similarity between the iris pattern of the person in the input image and the iris pattern of the registered person by pattern matching.

The collation unit 42 collates the person in the input image with all the persons registered in the person dictionary 50. Specifically, the collation unit 42 determines whether the similarity between the feature of the person detected by the person detection unit 20 and the feature of each person registered in the person dictionary 50 exceeds a threshold value.

In a case where the similarity calculated between the person in the input image acquired by the input unit 41 and any of the persons registered in the person dictionary 50 exceeds the threshold value, the collation unit 42 determines that a person same as the person in the input image acquired by the input unit 41 is registered in the person dictionary 50. The threshold value for the similarity used by the collation unit 42 may be different from or the same as the threshold value for the similarity used by the registration unit 34.

The collation unit 42 transmits information indicating a collation result to the output unit 43. This collation result indicates whether a person same as the person detected by the person detection unit 20 is registered in the person dictionary 50.

The output unit 43 receives information indicating a collation result from the collation unit 42. The output unit 43 determines whether to issue a notification instruction to the notification unit 60 based on the collation result. Specifically, in the case where the collation result indicates that a person same as the person detected by the person detection unit 20 is registered in the person dictionary 50, the output unit 43 does not issue the notification instruction.

In a case where the collation result indicates that a person same as the person detected by the person detection unit 20 is not registered in the person dictionary 50, the output unit 43 issues the notification instruction to the notification unit 60. The content of the notification instruction is to issue an alarm and inform the persons concerned of the danger.

The notification unit 60 will be described. When receiving the notification instruction from the output unit 43 of the biometrics device 40, the notification unit 60 issues an alarm by sound, light, display, or the like in accordance with the content of the notification instruction. Thus, the notification unit 60 notifies the persons concerned of the danger. That is, the notification unit 60 notifies the persons concerned via the alarm that a person not registered in the person dictionary 50 has been detected. The notification unit 60 is, for example, a speaker, a warning lamp, a display, or a wireless device.

Next, the operation of the biometrics device 40 will be described.

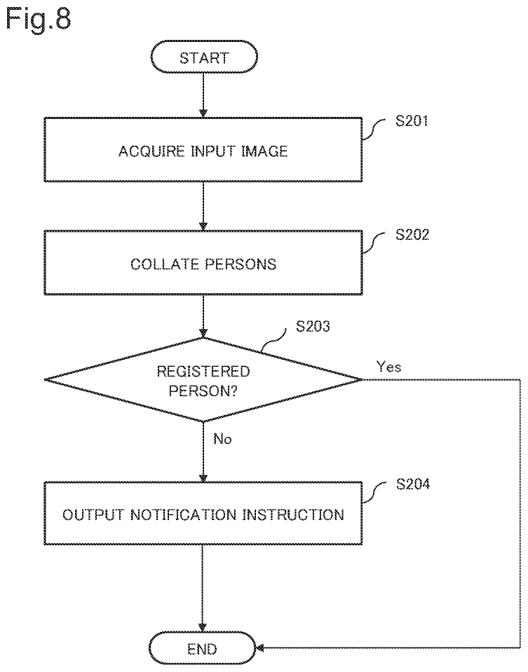

A flow of processing executed by each unit of the biometrics device 40 will be described with reference to the flowchart in FIG. 8. Hereinafter, it is assumed that the person dictionary 50 has already been generated by the dictionary creation device 30.

As illustrated in FIG. 8, the input unit 41 acquires one input image from the person detection unit 20 (see FIG. 1) of the monitoring system 1 (S201). The input unit 41 transmits the acquired input image to the collation unit 42. The collation unit 42 extracts the feature of a person from the input image acquired from the input unit 41. The feature of a person is, for example, a facial feature and an iris pattern. However, the collation unit 42 may extract any feature of the person.

The collation unit 42 collates the person included in the input image with each person registered in the person dictionary 50 (S202). For example, the collation unit 42 calculates the similarity between the facial feature of the person in the input image and the facial feature of the registered person. Alternatively, the collation unit 42 may calculate the similarity between the iris pattern of the person in the input image and the iris pattern of the registered person by pattern matching.

The collation unit 42 then transmits the information indicating a collation result to the output unit 43. The collation result indicates whether the person in the input image is registered in the person dictionary 50. In the above-described example, the collation unit 42 transmits the information indicating whether the calculated similarity exceeds the threshold value to the output unit 43.

The output unit 43 receives the information indicating the collation result from the collation unit 42. The output unit 43 determines whether to issue the notification instruction to the notification unit 60 based on the collation result (S203).

In a case where the collation result indicates that the person in the input image is not registered in the person dictionary 50 (No in S203), the output unit 43 issues the notification instruction to the notification unit 60 (S204). The operation of the biometrics device 40 thus ends.

In one modification, the biometrics device 40 may further include an erasing unit (not illustrated) that erases, from the person dictionary 50, the information regarding a person that is registered in the person dictionary 50 but has not been authenticated even once within a predetermined period. The predetermined period is, for example, one month. However, it is favorable to optionally set an appropriate predetermined period according to an environment in which the monitoring system 1 is used.

According to the configuration of the present modification, the information regarding a person whose frequency of entering the monitoring area has been decreased, can be erased from the person dictionary 50. Therefore, an enormous increase in the amount of data of the person images registered in the person dictionary 50 can be suppressed.

### Effects of Present Example Embodiments

According to the configuration of the present example embodiment, the person detection unit 20 transmits the plurality of images captured at intervals within the predetermined area to the dictionary creation device 30 during the registration period. The person detection unit 20 acquires the time-series images (a movie or a plurality of still images) from the camera 10. The time-series images are obtained by, for example, the camera 10 capturing the monitoring area at a preset time every day or at a predetermined time on a preset day every week.

The similarity calculation unit 33 calculates the similarities among the plurality of persons included in the plurality of images. More specifically, the similarity calculation unit 33 calculates the similarity between the feature of the first person included in one image of the plurality of images and the feature of the second person included in another image or a plurality of other images.

The registration unit 34 determines whether to register the person image related to each person to the person dictionary 50 based on the similarity calculated by the similarity calculation unit 33. In this manner, the dictionary creation device 30 can easily generate the person dictionary 50 that stores the information regarding a person without an input operation of a person who applies for registration such as the technique described in PTL 1.

Moreover, in the case where the feature of the first person included in one image of the plurality of images and the feature of the second person included in one or a plurality of images exceeds the threshold value, the registration unit 34 registers the person image related to the first person in the person dictionary 50. In other words, the registration unit 34 registers the person image related to the first person likely to be included in at least two images among the plurality of images in the person dictionary 50. Here, the threshold value of the similarity is used to discriminate whether the first person and the second person are likely to be the same.

The first person being included in equal to or more than two images means that the first person has appeared in the monitoring area at least twice. Therefore, the registration unit 34 can register the first person who has appeared in the monitoring area equal to or more than twice in the person dictionary 50. In this regard, the dictionary creation device 30 is different from the technique described in PTL 2 (JP 2004-157602 A). The technique disclosed in PTL 2 (JP 2004-157602 A) cannot discriminate a person unrelated to the facility or a suspicious person who has appeared in the monitoring area only once. On the other hand, the dictionary creation device 30 can prevent information regarding such a person from being registered in the person dictionary 50.

### Second Example Embodiment

Hereinafter, a second example embodiment of the present invention will be described.

A configuration of a monitoring system according to the present example embodiment is the same as the basic configuration of the monitoring system 1 of the first example embodiment (see FIG. 1). However, as will be described below, a dictionary creation device 230 according to the second example embodiment has a configuration different from that of the dictionary creation device 30 described in the first example embodiment.

Outlines of the dictionary creation device 230 according to the second example embodiment and the dictionary creation device 30 described in the first example embodiment are compared.

In the first example embodiment, in the case where the similarity between the first person and the second person exceeds a certain threshold value, the dictionary creation device 30 registers the first person in the person dictionary 50.

In contrast, in the present second example embodiment, the number of times the first person is detected reaching a certain threshold value is a condition to register the first person in a person dictionary 50 (hereinafter, the condition is referred to as a registration condition). In the second example embodiment, a face image related to the first person is stored in a temporary dictionary 235 (to be described below) provided in the dictionary creation device 230. A plurality of face images corresponding to a plurality of the first persons may be stored in the temporary dictionary 235.

Furthermore, in the present second example embodiment, the number of times the first person is detected from time-series images captured by a camera 10 (hereinafter the number of times will be referred to as a detection count) corresponds to an evaluation value. In other words, the number of images including the first person is related to the evaluation value. When the detection count for the first person reaches a threshold value, the dictionary creation device 230 registers information regarding the first person in the person dictionary 50.

The above-described registration condition may be set for each camera 10 (see FIG. 1) of a monitoring system 1 or for each group of cameras 10. For example, the threshold value of the detection count may be different for each camera 10.

Moreover, in the present second example embodiment, the registration condition may be flexibly changed according to a state of the first person. For example, the threshold value of the detection count that is the registration condition for the first person who is moving with another person may be smaller than that of another person. Furthermore, the threshold value of the detection count for the first person who is moving with a person registered in the person dictionary 50 may be further smaller. In this configuration, a registration unit 237 (see below) of the dictionary creation device 230 determines the state of the first person by using an identifier obtained by machine learning.

The configuration of the dictionary creation device 230 will be described.

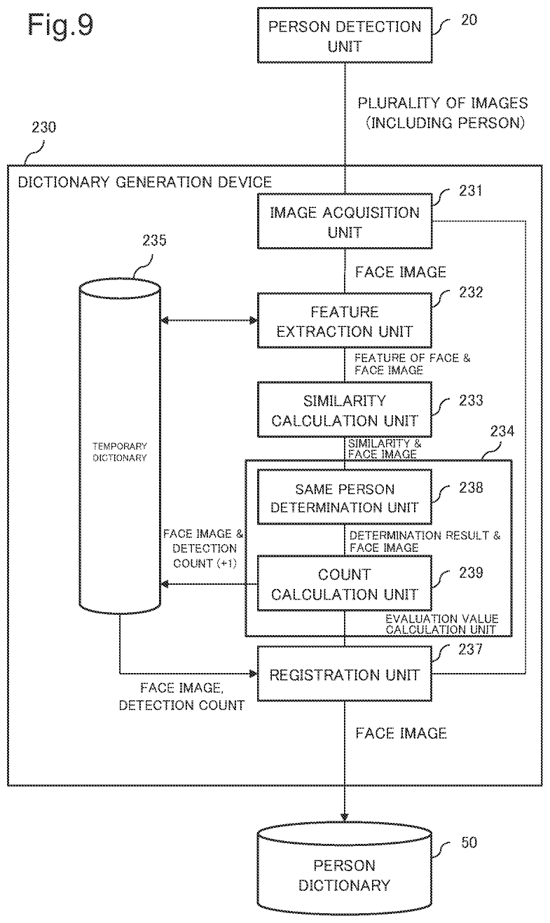

FIG. 9 is a block diagram illustrating the configuration of the dictionary creation device 230 according to the second example embodiment. As illustrated in FIG. 9, the dictionary creation device 230 includes an image acquisition unit 231, a feature extraction unit 232, a similarity calculation unit 233, an evaluation value calculation unit 234, the temporary dictionary 235, and the registration unit 237.

The image acquisition unit 231 is an example of an image acquisition means. The feature extraction unit 232 is an example of a feature extraction means. The similarity calculation unit 233 is an example of a similarity calculation means. The evaluation value calculation unit 234 includes a same person determination unit 238 and a count calculation unit 239. The evaluation value calculation unit 234 is an example of an evaluation value calculation means. The same person determination unit 238 is an example of a same person determination means. The count calculation unit 239 is an example of a count calculation means. The registration unit 237 is an example of a registration means.

The configuration of the dictionary creation device 230 according to the second example embodiment is compared with the configuration of the dictionary creation device 30 according to the first example embodiment. The dictionary creation device 230 is different from the dictionary creation device 30 in further including the same person determination unit 238, the count calculation unit 239, and the temporary dictionary 235. Furthermore, the dictionary creation device 230 is different from the dictionary creation device 30 in that the feature extraction unit 232, the count calculation unit 239, and the registration unit 237 are connected to the temporary dictionary 235.

The temporary dictionary 235 stores a face image and the evaluation value (the detection count of the person in the present example embodiment) related to the first person. In the temporary dictionary 235, the first persons different from each other are distinguished by information for specifying the first persons (for example, identifications: IDs).

A person detection unit 20 (see FIG. 1) acquires the time-series images (frame images of a movie or a plurality of still images captured at different timings) captured by the camera 10 at intervals within a predetermined area in real time. Each time the image acquisition unit 231 acquires one image from the person detection unit 20, the image acquisition unit 231 detects a region of a face of a second person from the acquired image. Then, the image acquisition unit 231 generates a face image including the region of the face of the second person. In a case where a plurality of the second persons is included in the image acquired from the person detection unit 20 by the image acquisition unit 231, the image acquisition unit 231 generates one face image for each of the second persons. That is, one face image includes the region of the face of one second person. The image acquisition unit 231 transmits the generated face image to the feature extraction unit 232.

The feature extraction unit 232 receives the face image related to the second person from the image acquisition unit 231. The feature extraction unit 232 detects the face of the second person from the received face image, and extracts a feature of the face of the second person. In a case where the temporary dictionary 235 is not empty, the feature extraction unit 232 acquires the face image related to the first person from the temporary dictionary 235. The feature extraction unit 232 extracts a feature of the face of the first person from the acquired face image. The feature extraction unit 232 transmits data of the feature of the face of the first person, and data in which the face image related to the second person and the feature of the face of the second person are associated with each other, to the similarity calculation unit 233.

The similarity calculation unit 233 receives the data of the feature of the face of the first person, and the data in which the face image related to the second person and the feature of the face of the second person are associated with each other, from the feature extraction unit 232.

The similarity calculation unit 233 then calculates a similarity between the feature of the face of the first person and the feature of the face of the second person. Hereinafter, the similarity between the feature of the face of the first person and the feature of the face of the second person will be referred to as the similarity between the first person and the second person or simply referred to as the similarity.

For example, the similarity calculation unit 233 calculates the similarity between the first person and the second person based on a distance and/or a direction between a feature vector representing the feature of the first person and a feature vector representing the feature of the second person. In this case, the similarity calculation unit 233 defines the similarity in such a manner that the similarity approaches 1 as the distance between the feature vectors becomes shorter or the directions are closer to each other, and the similarity approaches 0 as the distance between the feature vectors becomes longer or the directions are more distant from each other.

Alternatively, as described in the first example embodiment, the similarity calculation unit 233 may calculate the similarity between the first person and the second person based on a correlation coefficient between the feature vectors.

The similarity calculation unit 233 transmits data including the face image of the second person and a calculation result of the similarity to the same person determination unit 238 of the evaluation value calculation unit 234.

The same person determination unit 238 receives information including the face image of the second person and the calculation result of the similarity from the similarity calculation unit 233. The same person determination unit 238 determines whether the first person and the second person are the same by using the calculation result of the similarity received from the similarity calculation unit 233.

In the present second example embodiment, the first person and the second person being the same means that the similarity between these persons exceeds a certain threshold value. That is, in the case where the similarity between the first person and the second person exceeds the threshold value, the same person determination unit 238 determines that these persons are the same. The same person determination unit 238 transmits the face image of the second person and a determination result to the count calculation unit 239.

In a case where a plurality of face images related to a plurality of the first persons is stored in the temporary dictionary 235, the feature extraction unit 232 transmits the data of the features of the faces of the first persons, and data in which the face image related to the second person and the feature of the face of the second person are associated with each other, to the similarity calculation unit 233. The similarity calculation unit 233 calculates the similarity between each of the first persons and the second person. In the case where the similarities between the plurality of first persons and the second person exceed the threshold value, the same person determination unit 238 determines that the first person having the highest similarity to the second person is the same as the second person.

The count calculation unit 239 is connected to the temporary dictionary 235. In a case where the determination result by the same person determination unit 238 indicates that the second person is not the same as the first person, the count calculation unit 239 stores the face image of the second person as the face image of a new first person in the temporary dictionary 235. At this time, the count calculation unit 239 associates the face image of the new first person stored in the temporary dictionary 235 with information indicating “the detection count=1 (times)”. In the temporary dictionary 235, the new first person is distinguished from the other first persons by the information for specifying the new first person.

On the other hand, in a case where the determination result by the same person determination unit 238 indicates that the first person and the second person are the same, the count calculation unit 239 increments (+1) the detection count associated with the face image of the first person in the temporary dictionary 235. In this way, during a registration period, the evaluation value calculation unit 234 calculates the detection count of the first person as an evaluation value that changes depending on the similarity. In a case where there is a plurality of the first persons, the evaluation value calculation unit 234 calculates the evaluation value for each first person.

The count calculation unit 239 transmits the information (for example, the ID) for specifying the first person to the registration unit 237 and also notifies the registration unit 237 that the temporary dictionary 235 has been updated.

The registration unit 237 is connected to the temporary dictionary 235 and the person dictionary 50. The registration unit 237 is notified by the count calculation unit 239 that the temporary dictionary 235 has been updated together with the information for specifying the first person (for example, the ID).

The registration unit 237 refers to the temporary dictionary 235 and determines whether the detection count of the first person has reached a threshold value. In a case where the detection count of the first person has reached the threshold value, the registration unit 237 acquires the face image related to the first person from the temporary dictionary 235 and registers the acquired face image in the person dictionary 50. Thereafter, the registration unit 237 erases the face image of the first person registered in the person dictionary 50 and the data indicating the detection count from the temporary dictionary 235.

Next, the operation of the dictionary creation device 230 will be described.

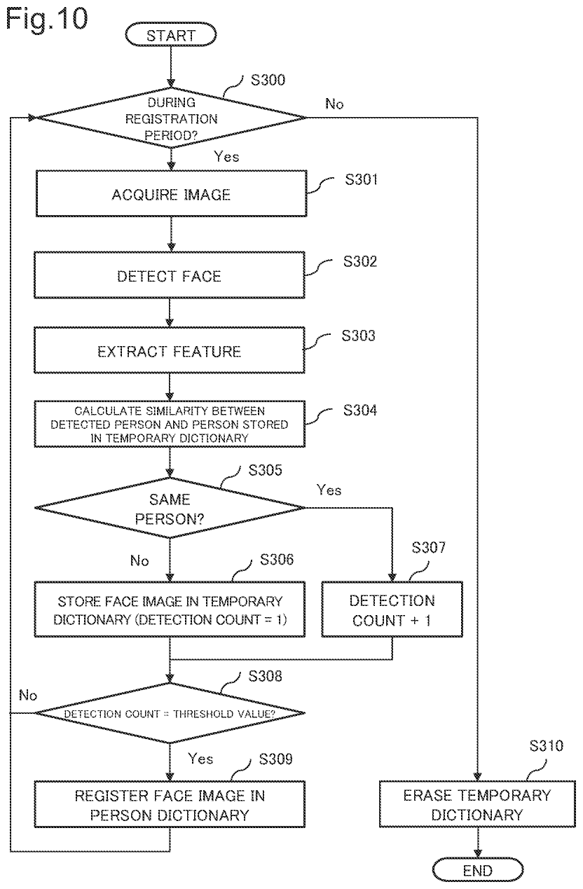

FIG. 10 is a flowchart illustrating a flow of processing executed by the dictionary creation device 230 during the registration period. Each unit of the dictionary creation device 230 starts the processing to be described below after the image acquisition unit 231 receives a start signal from the person detection unit 20.

As illustrated in FIG. 10, the image acquisition unit 231 determines whether it is during the registration period based on the start signal and an end signal received from the person detection unit 20 (S300). In a case where it is not during the registration period (No in S300), the flow proceeds to step S310 to be described below.

In a case where it is during the registration period (Yes in S300), the image acquisition unit 231 acquires a plurality of images captured at intervals within a predetermined area from the person detection unit 20 (S301). In step S301, the image acquisition unit 231 may acquire one image at a time in real time each time the camera 10 captures the image or may collectively acquire a plurality of images from the person detection unit 20. The former example will be described below.

The image acquisition unit 231 detects a region of one or a plurality of second persons from the acquired image (S302). Then, the image acquisition unit 231 generates a face image including the detected region of the second person. In a case where the image acquired by the image acquisition unit 231 includes a plurality of the second persons, the image acquisition unit 231 generates a plurality of face images each including only the region of one second person from the acquired image. Thus, each face image includes the region of the face of one second person. The image acquisition unit 231 transmits the generated face image to the feature extraction unit 232. Hereinafter, the case where the image acquisition unit 231 generates only one face image will be described. This corresponds to the case where the image acquired by the image acquisition unit 231 from the person detection unit 20 includes only one second person. In the case where the image acquisition unit 231 generates the plurality of face images corresponding to the plurality of second persons from the acquired image, processing to be described below is executed for each face image.

The feature extraction unit 232 receives the face image related to the second person from the image acquisition unit 231.

The feature extraction unit 232 acquires a face image related to the first person by referring to the temporary dictionary 235. The feature extraction unit 232 extracts the feature of the face of the first person from the face image acquired from the temporary dictionary 235. Furthermore, the feature extraction unit 232 extracts the feature of the face of the one second person from the face image received from the image acquisition unit 231 (S303).

The feature extraction unit 232 transmits the data of the feature of the face of the first person, and data in which the face image related to the second person and the feature of the face of the second person extracted from the face image are associated with each other, to the similarity calculation unit 233.

The similarity calculation unit 233 receives the data of the feature of the face of the first person, and the data in which the face image related to the second person and the feature of the face of the second person are associated with each other, from the feature extraction unit 232.

The similarity calculation unit 233 then calculates the similarity between the feature of the first person and the feature of the second person (S304). Here, in a case where there is a plurality of first persons, that is, a plurality of face images is stored in the temporary dictionary 235, the similarity calculation unit 233 calculates the similarities between all the first persons and the second person in step S304. The processing to be described below is also performed for all the first persons.

The similarity calculation unit 233 transmits the calculation result of the similarity in step S304 and the face image related to the second person to the same person determination unit 238.

The same person determination unit 238 receives information including the face image related to the second person and the calculation result of the similarity from the similarity calculation unit 233. The same person determination unit 238 determines whether the first person and the second person are the same by using the calculation result of the similarity received from the similarity calculation unit 233 (S305).

The same person determination unit 238 transmits the face image related to the second person and information including the determination result in step S305 to the count calculation unit 239.

The count calculation unit 239 receives the determination result in step S305, that is, information indicating whether the first person and the second person are the same, together with the face image related to the second person, from the same person determination unit 238.

In a case where the determination result by the same person determination unit 238 indicates that the second person is not the same as the first person (No in S305), the count calculation unit 239 stores, in the temporary dictionary 235, the face image of the second person as the face image of a new first person in association with information indicating “the detection count=1” (S306).

The count calculation unit 239 transmits the information (for example, the ID) for specifying the first person to the registration unit 237 and also notifies the registration unit 237 that the temporary dictionary 235 has been updated. The flow then proceeds to step S308.

On the other hand, in a case where the determination result by the same person determination unit 238 indicates that the first person and the second person are the same (Yes in S305), the count calculation unit 239 increases, by 1, the detection count associated with the face image related to the first person in the temporary dictionary 235 (S307). The count calculation unit 239 notifies the registration unit 237 of the information (for example, the ID) for specifying the first person and notifies the registration unit 237 that the temporary dictionary 235 has been updated.

After step S306 or S307 illustrated in FIG. 10, the registration unit 237 receives the information for specifying the first person and is notified that the temporary dictionary 235 has been updated, from the count calculation unit 239. When receiving the notification from the count calculation unit 239, the registration unit 237 refers to the temporary dictionary 235 and determines whether the detection count of the first person has reached the threshold value (S308).

In a case where the detection count of the first person has reached the threshold value (Yes in S308), the registration unit 237 acquires the face image of the first person from the temporary dictionary 235 and registers the acquired face image in the person dictionary 50 (S309). Thereafter, the registration unit 237 erases the face image related to the first person registered in the person dictionary 50 and the information on the detection count of the first person from the temporary dictionary 235.

Before step S309, the registration unit 237 may determine whether the face image of the first person to be registered in the person dictionary 50 has already been registered in the person dictionary 50. For example, the registration unit 237 extracts the features from the face image related to the first person and the face image related to the registered person stored in the person dictionary 50. Then, in a case where the similarity between the extracted features exceeds a predetermined threshold value, the registration unit 237 determines that the face image related to the first person has already been registered in the person dictionary 50. Then, in a case where the face image related to the first person has already been registered in the person dictionary 50, the registration unit 237 stops registering the face image related to the first person in the person dictionary 50. Thereby, a plurality of face images related to the same first person can be prevented from being stored in the person dictionary 50.

In a case where the registration unit 237 determines that the detection count of the first person has not reached the threshold value (No in S308), or after step S309, the image acquisition unit 231 determines whether it is during the registration period again based on the start signal and end signal received from the person detection unit 20 (S300). Note that, in the case where the image acquisition unit 231 has generated a plurality of face images related to a plurality of second persons in step S302 described above, the flow returns to step S303 when No in step S308 or after step S309. Then, the image acquisition unit 231 detects the region of the face of another second person from another face image.

In a case where it is still during the registration period (Yes in S300), the flow returns to step S301, and the image acquisition unit 231 acquires another image from the person detection unit 20. Then, each unit of the dictionary creation device 230 executes the flow illustrated in FIG. 10 again.

After the registration period ends (No in S300), the image acquisition unit 231 notifies the registration unit 237 that the registration period has ended. After receiving the notification of the end of the registration period from the image acquisition unit 231, the registration unit 237 erases the data regarding all the first persons stored in the temporary dictionary 235 (S310). Alternatively, in step S310, the registration unit 237 may reset the detection counts associated with all the first persons in the temporary dictionary 235 to zero. Thus, the operation of the dictionary creation device 230 ends.

In one modification, the registration unit 237 executes the processing corresponding to steps S308 to S309 only once before executing the processing step S310 after the registration period ends (No in S300) without performing the processing of registering the face image related to the first person in the person dictionary 50 during the registration period (steps S308 to S309 described above). That is, in the present modification, after notified that the registration period has ended from the image acquisition unit 231, the registration unit 237 determines whether the detection count has reached the threshold value for each of all the first persons stored in the temporary dictionary 235. Then, the registration unit 237 specifies the first person with the detection count having reached the threshold value, and registers the face image related to the specified first person in the person dictionary 50. Thereafter, the registration unit 237 erases the face images of all the first persons and the data of the detection counts from the temporary dictionary 235 (S310).

Even in the present second example embodiment, the feature of the first person may be registered in the person dictionary 50 as the information regarding the first person, similarly to the first example embodiment.

For example, the feature extraction unit 232 extracts an iris pattern from the face image related to the second person generated by the image acquisition unit 231. Furthermore, the feature extraction unit 232 acquires the face image related to the first person by referring to the temporary dictionary 235, and extracts an iris pattern of the first person from the acquired face image related to the first person.

The feature extraction unit 232 transmits data of the iris pattern of the first person, and data in which an image including the iris of the second person (or an image including a region of a pupil or an eye of the second person) and the iris pattern of the second person are associated with each other, to the similarity calculation unit 233.

The similarity calculation unit 233 calculates the similarity between the iris pattern of the first person and the iris pattern of the second person.

The evaluation value calculation unit 234 calculates the detection count of the first person based on the similarity calculated by the similarity calculation unit 233. The detection count of the first person is an example of the evaluation value depending on the similarity. The registration unit 237 determines whether to register the information regarding the first person in the person dictionary 50 based on the evaluation value (detection count) calculated by the evaluation value calculation unit 234. In a case where the evaluation value (detection count) of the first person has reached the value, the registration unit 237 registers an image including a region of an eye or a pupil of the first person and/or the iris pattern in the person dictionary 50.

(Use Case)

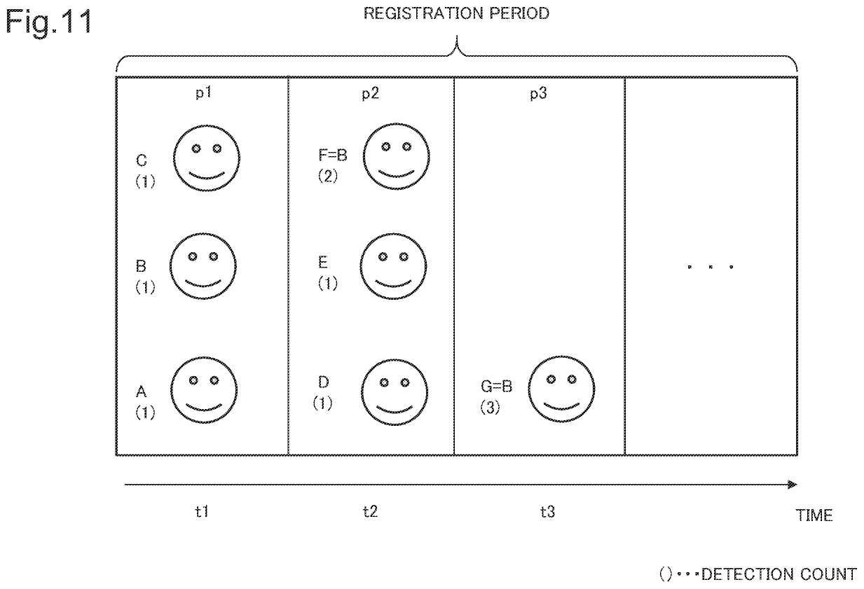

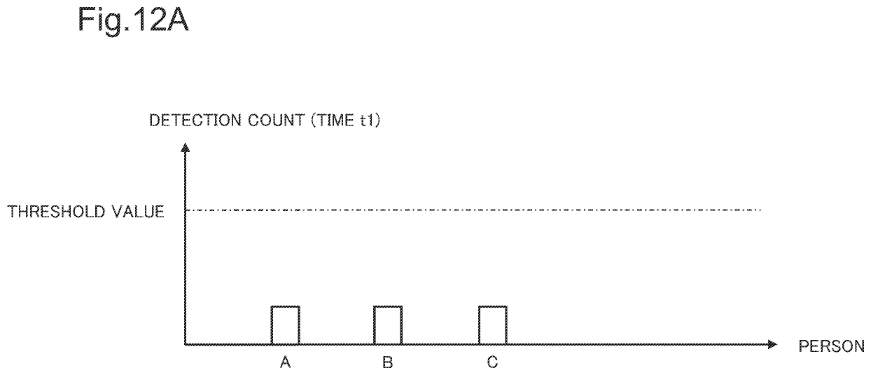

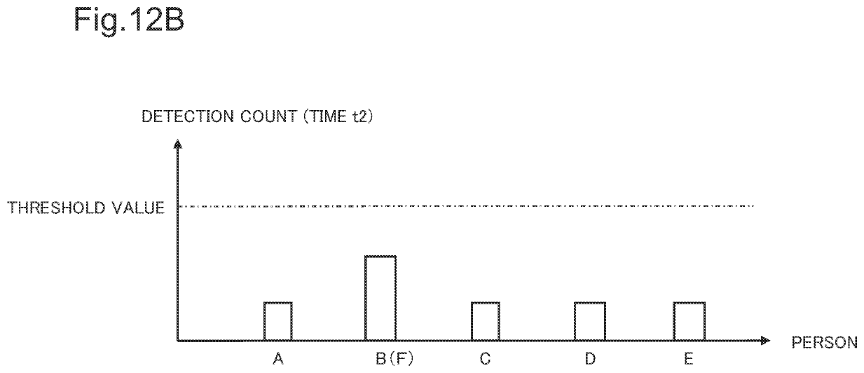

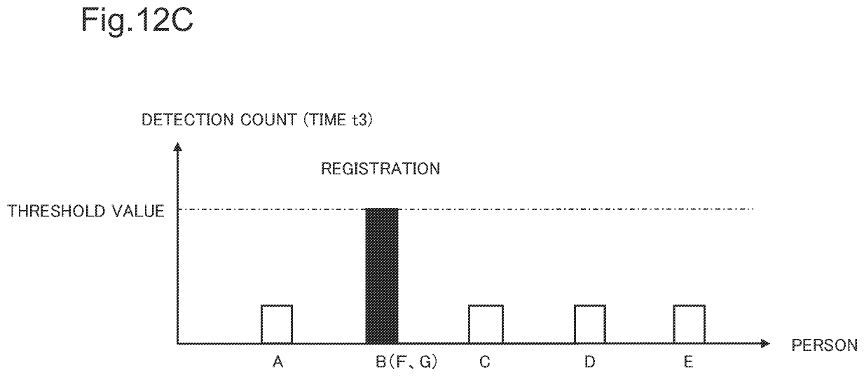

A use case of the monitoring system 1 provided with the dictionary creation device 230 according to the present second example embodiment will be described with reference to FIG. 11 and FIGS. 12A to 12C. Here, the camera 10 captures an image p1 at time t1, captures an image p2 at time t2, and captures an image p3 at time t3.

FIG. 11 illustrates the time-series (t1, t2, t3, and the like) images p1, p2, p3, and the like, and persons A to G included in at least one of the images p1 to p3.

As illustrated in FIG. 11, the image p1 at time t1 includes the persons A, B, and C. The image p2 at time t2 includes the persons D, E, and F. The image p3 at time t3 includes the person G. In FIG. 11, “F=B” and “G=B” indicate that the same person determination unit 238 has determined that the persons F and G are the same as the person B. The other persons A to E are determined to be different persons from each other. In FIG. 11, the numbers in the parentheses below the characters of the persons indicate the detection counts of the respective persons at time t1 to t3.

Conditions for the use case are as follows.

(1) Use environment: a cram school that opens once a week from the 2nd week of April, 17:00 to 19:00 on a certain day.

(2) One camera 10 is installed in front of a classroom. The camera 10 captures an image once during 17:00 to 19:00 of every lecture day. The time t1, t2, t3, and the like at which the camera 10 captures an image is preset by a timer. The time t1 illustrated in FIG. 11 is time between 17:00 to 19:00 on the lecture day in the 2nd week of April. The time t2 is time between 17:00 to 19:00 of the lecture day in the 3rd week of April. The time t3 is time between 17:00 to 19:00 of the lecture day in the 4th week of April.

(3) Registration period: from the 2nd to 4th weeks of April

(4) Registration condition: the threshold value for the detection count is 3

(The lecture day of the 2nd week of April)

The camera 10 performs the first capture at time t1 during 17:00 to 19:00 of the lecture day in the 2nd week of April to generate the first image p1. The image p1 is transmitted from the camera 10 to the person detection unit 20.

The person detection unit 20 detects the persons A to C included in the image p1. Since the present time is during the registration period, the person detection unit 20 transmits the image p1 to the dictionary creation device 230 (see S4 in FIG. 2).

In the procedure illustrated in FIG. 10 (in particular, steps S304 to S306), the count calculation unit 239 of the dictionary creation device 230 stores data in which the face images of the persons A to C and the “detection count=1” are associated with each other in the temporary dictionary 235.

FIG. 12A illustrates the detection counts of the persons A to C detected by the person detection unit 20 at time t1 of the lecture day in the 2nd week of April. As illustrated in FIG. 12A, in the 2nd week of April, the detection counts of all the persons A to C are 1 and do not satisfy the registration condition. Therefore, the registration unit 237 of the dictionary creation device 230 does not register the face images of the persons A to C in the person dictionary 50.

(The Lecture Day of the 3rd Week of April)

The camera 10 performs the second capture at time t2 during 17:00 to 19:00 of the lecture day in the 3rd week of April to generate the second image p2. The image p2 is transmitted from the camera 10 to the person detection unit 20.

The person detection unit 20 detects the persons D to F from the image p2. Since the present time is during the registration period, the person detection unit 20 transmits the image p2 to the dictionary creation device 230.

In the procedure illustrated in FIG. 10, the same person determination unit 238 of the dictionary creation device 230 determines that the person B and the person F are the same. Therefore, the count calculation unit 239 of the dictionary creation device 230 increases, by 1, the detection count associated with the face image of the person B in the temporary dictionary 235. Furthermore, the same person determination unit 238 of the dictionary creation device 230 determines that the persons D and E are not the same as the persons A to C. Therefore, the count calculation unit 239 of the dictionary creation device 230 stores data in which the face images of the persons D and E and the “detection count=1” are associated with each other in the temporary dictionary 235.

FIG. 12B illustrates the detection counts of the persons A to E detected at time t2 of the lecture day in the 3rd week of April. The detection count of the person B on the lecture day in the 3rd week of April has increased by 1 from the lecture day in the 2nd week of April. As illustrated in FIG. 12B, in the 3rd week of April, the detection count of none of the persons A to E has reached the threshold value. Therefore, the registration unit 237 of the dictionary creation device 230 does not register the face images of the persons A to E in the person dictionary 50.

(The Lecture Day of the 4th Week of April)

The camera 10 generates the third image p3 at time t3 during 17:00 to 19:00 of the lecture day in the 4th week of April. The image p3 is transmitted from the camera 10 to the person detection unit 20.

The person detection unit 20 detects the person G included in the image p3. Since the present time is during the registration period, the person detection unit 20 transmits the image p3 to the dictionary creation device 230.

In the procedure illustrated in FIG. 10, the same person determination unit 238 of the dictionary creation device 230 determines that the person B and the person G are the same. Therefore, the count calculation unit 239 of the dictionary creation device 230 increases, by 1, the detection count associated with the face image of the person B in the temporary dictionary 235.

FIG. 12C illustrates the detection counts of the persons A to E at time t3 of the lecture day in the 4th week of April. The detection count of the person B on the lecture day in the 4th week of April has increased by 1 from the lecture day in the 3rd week of April.

As illustrated in FIG. 12C, in the 4th week of April, the detection count of the person B has reached the threshold value. Therefore, the registration unit 237 of the dictionary creation device 230 registers the face image of the person B in the person dictionary 50. The detection count of none of the other persons has reached the threshold value. Therefore, the registration unit 237 of the dictionary creation device 230 does not register the face images of the persons other than the person B in the person dictionary 50.

In the above-described example, the registration condition is the same for all the persons A to E, and thus only the face image related to the person B is registered in the person dictionary 50. However, if the registration condition is different for each of the persons A to E, the person registered in the person dictionary 50 changes. For example, the threshold value of the detection count only for the person A may be 2. Alternatively, the registration period may be extended to May only for the person E.

### Effects of Present Example Embodiments

According to the present example embodiment, the similarity calculation unit 233 as the similarity calculation means calculates the similarity between the first person and one or a plurality of the second persons. More specifically, the similarity calculation unit 233 calculates the similarity between the feature of the first person included in one image of the plurality of time-series images and the feature of the second person included in another image or a plurality of other images.

The count calculation unit 239 as the second means of the evaluation value calculation means calculates the detection count of the first person. Furthermore, the registration unit 237 as the registration means determines whether to register the information regarding the first person in the person dictionary 50 based on the detection count of the first person during the registration period.

For example, the count calculation unit 239 calculates the number of times the first person enters or leaves the facility. In this configuration, the registration unit 237 registers, in the person dictionary 50, the first person who has entered and left the facility equal to or more than a predetermined detection count during the registration period. The more frequently a person enters or leaves the facility, the more likely the person is a person concerned of the facility or a person who knowns a person concerned, and is not a suspicious person.

As a result, the dictionary creation device 230 can easily generate the person dictionary 50 that stores the information regarding persons, similarly to the dictionary creation device 30 in the first example embodiment. As in the technique described in PTL 1, it is not necessary for a person and an administrator to manually generate a dictionary that stores information regarding the person.

Moreover, the dictionary creation device 230 determines whether to register the person in the dictionary based on the detection count of the person. Thereby, a person (for example, a suspicious person) who should not be registered in the dictionary can be prevented from being registered in the person dictionary 50 without making determination, as compared with the technique described in PTL 2.

### Third Example Embodiment

Another example embodiment of the present invention will be described below.

A configuration of a monitoring system according to a third example embodiment will be described.

A basic configuration of a monitoring system according to the present third example embodiment is the same as that of the monitoring system 1 of the first example embodiment (see FIG. 1). However, as will be described below, a dictionary creation device 330 according to the third example embodiment has a configuration different from that of the dictionary creation device 230 described in the second example embodiment.

Here, outlines of the dictionary creation device 330 according to the third example embodiment and the dictionary creation device 230 described in the second example embodiment are compared.

In the second example embodiment, the detection count of a person has corresponded to the evaluation value of the present invention. Furthermore, in the second example embodiment, the registration condition has been that the detection count of a person reaches a certain threshold value during the registration period. Meanwhile, an evaluation value of a person in the present third example embodiment is a cumulative value of a similarity between a first person and a second person. Furthermore, in the present third example embodiment, a registration condition is that the cumulative value of the similarity exceeds a certain threshold value. The threshold value in the registration condition of the third example embodiment is different from the threshold value in the registration condition of the second example embodiment.

Next, a configuration of the dictionary creation device 330 will be described.

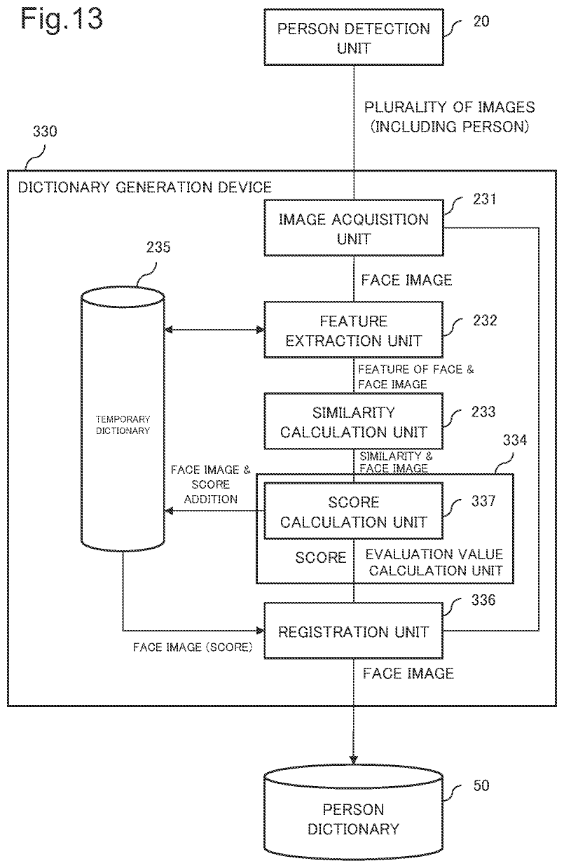

FIG. 13 is a block diagram illustrating the configuration of the dictionary creation device 330 according to the third example embodiment. As illustrated in FIG. 13, the dictionary creation device 330 includes an image acquisition unit 231, a feature extraction unit 232, a similarity calculation unit 233, an evaluation value calculation unit 334, a temporary dictionary 235, and a registration unit 336. The image acquisition unit 231 is an example of an image acquisition means. The feature extraction unit 232 is an example of a feature extraction means. The similarity calculation unit 233 is an example of a similarity calculation means. The evaluation value calculation unit 334 includes a score calculation unit 337. The evaluation value calculation unit 334 is an example of an evaluation value calculation means. The registration unit 336 is an example of a registration means.

Here, the configuration of the dictionary creation device 330 in the third example embodiment is compared with the configuration of the dictionary creation device 230 in the second example embodiment.

The image acquisition unit 231, the feature extraction unit 232, the similarity calculation unit 233, and the temporary dictionary 235 of the configuration elements of the dictionary creation device 330 in FIG. 13 are common to the configuration elements of the dictionary creation device 230 (see FIG. 9) according to the second example embodiment. Note that, in the present third example embodiment, the temporary dictionary 235 stores data in which a face image related to the first person is associated with a score of the first person. In the present third example embodiment, description of these units is omitted.

In the dictionary creation device 230 according to the second example embodiment, the evaluation value calculation unit 234 includes the same person determination unit 238 and the count calculation unit 239, whereas in the dictionary creation device 330 according to the present third example embodiment, the evaluation value calculation unit 334 includes the score calculation unit 337. In this regard, the dictionary creation device 230 and the dictionary creation device 330 are different from each other.

The score calculation unit 337 calculates the score of the first person. More specifically, the score calculation unit 337 calculates a cumulative value obtained by summing all of similarities between the first person related to the face image stored in the temporary dictionary 235 and the second person related to another face image stored in the temporary dictionary 235 as the score of the first person.

The score calculation unit 337 notifies the registration unit 336 of the score of the first person together with information (for example, an ID) for specifying the first person.

The registration unit 336 is connected to the temporary dictionary 235 and the person dictionary 50. The registration unit 336 is notified, from the score calculation unit 337, the score of the first person together with the information (for example, the ID) for specifying the first person.

The registration unit 336 determines whether the score of the first person has exceeded a threshold value. More specifically, the registration unit 336 checks the magnitude relationship between the score of the first person and the threshold value.

In a case where the score of the first person has exceeded the threshold value, the registration unit 336 registers the face image related to the first person in a person dictionary 50. Thereafter, the registration unit 336 erases the information regarding the first person from the temporary dictionary 235.

Next, the operation of the dictionary creation device 330 will be described.

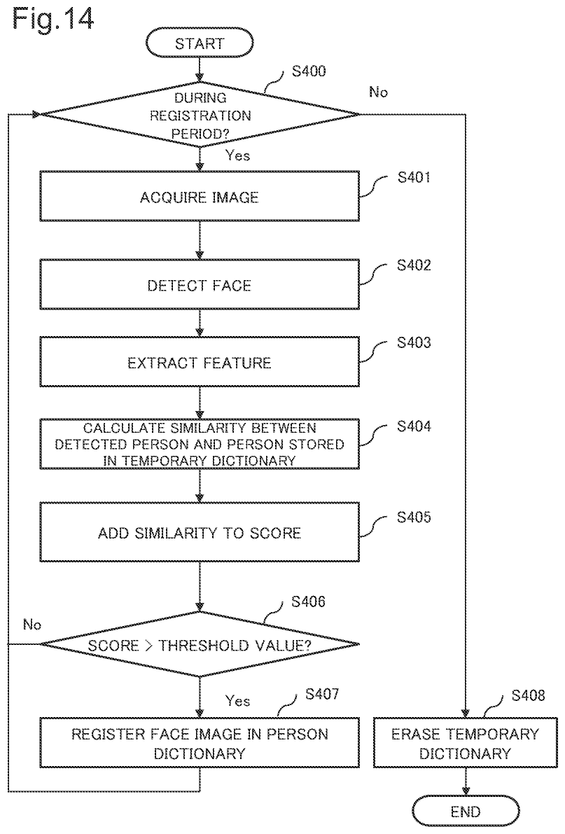

FIG. 14 is a flowchart illustrating a flow of processing executed by the dictionary creation device 330 according to the third example embodiment during a registration period. Each unit of the dictionary creation device 330 starts processing to be described below after the image acquisition unit 231 receives a start signal from a person detection unit 20.

As illustrated in FIG. 14, the image acquisition unit 231 determines whether it is during the registration period based on the start signal and an end signal received from the person detection unit 20 (S400). In a case where it is not during the registration period (No in S400), the flow proceeds to step S408 to be described below.

In a case where it is during the registration period (Yes in S400), the image acquisition unit 231 acquires a plurality of images captured at intervals within a predetermined area from the person detection unit 20 (S401). The image acquisition unit 231 may acquire one image at a time in real time each time the camera 10 captures the image or may collectively acquire a plurality of images from the person detection unit 20. The former example will be described below.

The image acquisition unit 231 detects a region of the face of the second person from the acquired image (S402). The image acquisition unit 231 generates a face image including the region of the face of the second person, and transmits the generated face image to the feature extraction unit 232. In a case where a plurality of the second persons is included in the image acquired by the image acquisition unit 231, the image acquisition unit 231 generates a plurality of face images corresponding to the plurality of second persons. In this case, the processing to be described below is executed for each face image corresponding to one second person.

The feature extraction unit 232 refers to the temporary dictionary 235. Then, the feature extraction unit 232 extracts a feature of the face of the first person from the face image stored in the temporary dictionary 235. Furthermore, the feature extraction unit 232 acquires the face image from the image acquisition unit 231 and extracts a feature of the face of the second person from the acquired face image (S403). Here, in a case where a plurality of face images corresponding to a plurality of first persons is stored in the temporary dictionary 235, the feature extraction unit 232 extracts features of the faces of the plurality of first persons.

The feature extraction unit 232 transmits data of the feature of the face of the first person, and data in which the face image related to the second person and the feature of the face of the second person are associated with each other, to the similarity calculation unit 233.

The similarity calculation unit 233 receives the data of the feature of the face of the first person, and the data in which the face image related to the second person and the feature of the face of the second person are associated with each other, from the feature extraction unit 232.

The similarity calculation unit 233 calculates the similarity between the feature of the first person and the feature of the second person (S404). In a case where the plurality of face images corresponding to the plurality of first persons is received from the feature extraction unit 232, in step S404, the similarity calculation unit 233 calculates the similarities between all first persons and the second person.

The score calculation unit 337 refers to the score associated with the face image related to the first person in the temporary dictionary 235. Then, the score calculation unit 337 adds the similarity calculated by the similarity calculation unit 233 to the score of the first person (S405). The score calculation unit 337 updates the score of the first person stored in the temporary dictionary 235 with the score added with the similarity.

Furthermore, the score calculation unit 337 stores the face image related to the second person as the face image related to a new first person in association with information indicating the “score=0” in the temporary dictionary 235. In this way, the score calculation unit 337 of the evaluation value calculation unit 334 calculates the score as an evaluation value that changes depending on the similarity.

The score calculation unit 337 may notify the registration unit 336 that the temporary dictionary 235 has been updated. In this case, the registration unit 336 acquires information on the score of the first person stored in the temporary dictionary 235 from the temporary dictionary 235.

The registration unit 336 determines whether the score of the first person satisfies the registration condition (S406).

Specifically, the registration unit 336 determines whether the score of the first person has exceeded the threshold value. In a case where a plurality of face images corresponding to a plurality of first persons is stored in the temporary dictionary 235, the registration unit 336 determines whether the score of each first person has exceeded the threshold value.

In a case where the score of the first person has exceeded the threshold value (Yes in S406), the registration unit 336 acquires the face image related to the first person from the temporary dictionary 235 and registers the acquired face image in the person dictionary 50 (S407). Thereafter, the registration unit 336 erases the face image related to the first person and the data of the score from the temporary dictionary 235. In step S406, in a case where the scores of the plurality of first persons have exceeded the threshold value, the registration unit 336 registers the face images related to the first persons in the person dictionary 50.

Before step S407, the registration unit 336 may determine whether the face image of the first person to be registered in the person dictionary 50 has already been registered in the person dictionary 50. For example, the registration unit 336 extracts the features from the face image related to the first person and the face image related to the registered person stored in the person dictionary 50. Then, in a case where the similarity between the extracted features exceeds a predetermined threshold value, the registration unit 336 determines that the face image related to the first person has already been registered in the person dictionary 50. Then, in a case where the face image related to the first person has already been registered in the person dictionary 50, the registration unit 336 stops registering the face image related to the first person in the person dictionary 50. Thereby, a plurality of face images related to the same first person can be prevented from being stored in the person dictionary 50.

After step S407 or in a case where the score of the first person (all the first persons in the case whether there is a plurality of first persons) does not exceed the threshold value (No in step S406), the image acquisition unit 231 determines whether it is during the registration period based on the start signal and end signal received from the person detection unit 20 (S400). Note that, in the case where the image acquisition unit 231 has generated a plurality of face images related to a plurality of second persons in step S402 described above, the flow returns to step S403 when No in step S406 or after step S407. Then, the image acquisition unit 231 detects the region of the face of another second person from another face image.

In a case where it is still during the registration period (Yes in S400), the flow returns to step S401, and the image acquisition unit 231 acquires another image from the person detection unit 20. Then, each unit of the dictionary creation device 330 executes the flow again.

After the registration period ends (No in S400), the image acquisition unit 231 notifies the registration unit 336 that the registration period has ended. After notified from the image acquisition unit 231 that the registration period has ended, the registration unit 336 erases the face images and the score data of all the first persons from the temporary dictionary 235 (S408). Alternatively, in step S408, the registration unit 336 may reset all the scores associated with the first persons in the temporary dictionary 235 to zero. Thus, the operation of the dictionary creation device 330 ends.

In one modification, the registration unit 336 executes the processing corresponding to steps S406 and S407 only once after the registration period ends (No in S400) without performing the processing of registering the face image related to the first person in the person dictionary 50 during the registration period (steps S406 and S407 described above). That is, in the present modification, after notified that the registration period has ended from the image acquisition unit 231, the registration unit 336 determines whether the scores exceed the threshold value for all the first persons stored in the temporary dictionary 235. Then, the registration unit 336 specifies the first person with the score exceeding the threshold value, and registers the face image related to the specified first person in the person dictionary 50. Thereafter, the registration unit 336 erases the face images of all the first persons and the data of the scores from the temporary dictionary 235 (S408).

A specific example of the score calculated by the score calculation unit 337 (see FIG. 13) according to the present third example embodiment in the flow illustrated in FIG. 14 will be described with reference to FIG. 11. FIG. 11 illustrates time-series images p1 to p3 and persons A to G included in the images p1 to p3. In each flow, the image acquisition unit 231 acquires the images p1 to p3 one by one in this order.

The image acquisition unit 231 acquires the image p1 in the first flow after the start of the registration period. The image p1 includes the persons A to C. The persons A to C correspond to the second persons. At this time, the temporary dictionary 235 is still empty. That is, the first person does not exist. Therefore, in this flow, the similarity calculation unit 233 does not perform the processing of calculating the similarity between the first person and the second person. The score calculation unit 337 stores the face images related to the persons A to C as the face images related to a new first person in association with information indicating the “score=0” in the temporary dictionary 235.

In the second flow, the image acquisition unit 231 acquires the image p2. The image p2 includes the persons D to F. The similarity calculation unit 233 calculates the similarities between the persons A to C as the first persons and the persons D to F as the second persons. The score calculation unit 337 adds the cumulative values of the similarities between the persons A to C and the persons D to F to the scores associated with the face images of the persons A to C in the temporary dictionary 235.

For example, it is assumed that the similarity between the person A and the person D is 0.64, the similarity between the person A and the person E is 0.49, and the similarity between the person A and the person F is 0.88. In this case, the cumulative value of the similarities between the person A and the persons D to F is 0.64+0.49+0.88=2.01. Therefore, the score calculation unit 337 adds 2.01 to the score of the person A.

Similarly, the score calculation unit 337 adds the cumulative values of the similarities between the persons B and C and the persons D to F to the scores of the persons B and C. Furthermore, the score calculation unit 337 stores the face images related to the persons D to F included in the image p2 as the face images related to a new first person in association with information indicating the “score=0” in the temporary dictionary 235.

In the third flow, the image acquisition unit 231 acquires the image p3. The image p3 includes the person G. The similarity calculation unit 233 calculates the similarities between the persons A to F as the first persons and the person G as the second person. The score calculation unit 337 adds the similarities between the persons A to F and the person G to the scores associated with the face images of the persons A to F in the temporary dictionary 235.

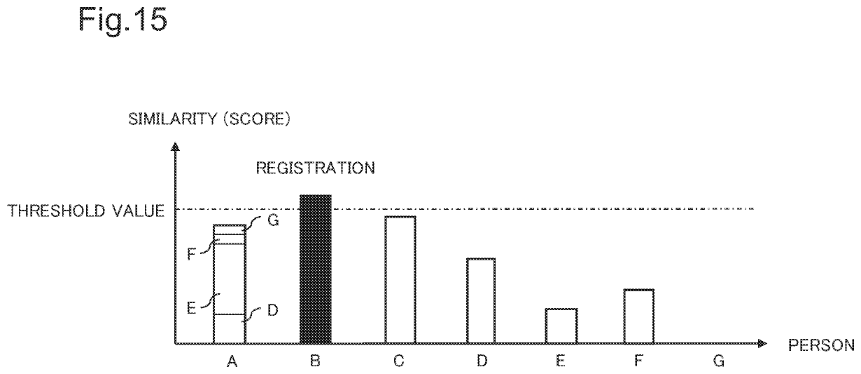

FIG. 15 illustrates an example of the scores of the persons A to G at the time of completion of the third flow. In FIG. 15, the score of the person A is a value obtained by accumulating the similarities between the person A and the persons D to G. In FIG. 15, in the bar graph relating to the person A, the small blocks denoted by reference numerals D to G represent the similarities between the person A and the persons D to G. A stack of these small blocks represents the score of the person A.

In FIG. 15, only the score of the person B among the persons A to G exceeds the threshold value. In this case, the registration unit 336 (see FIG. 13) according to the present third example embodiment registers the face image related to the person B in the person dictionary 50 (see FIG. 1).

In the person dictionary 50, information other than the face image of the first person may be registered as information regarding a person. In one modification, an iris pattern of a person is registered in the person dictionary 50.

In this case, the feature extraction unit 232 extracts an iris pattern from the face image related to the second person instead of or in addition to the feature of the face of the person. Furthermore, the feature extraction unit 232 acquires the face image related to the first person by referring to the temporary dictionary 235, and extracts an iris pattern of the first person from the acquired face image related to the first person.

The feature extraction unit 232 transmits data of the iris pattern of the first person, and data in which an image including the iris of the second person (or an image including a region of a pupil or an eye of the person) and the iris pattern of the second person are associated with each other, to the similarity calculation unit 233. The similarity calculation unit 233 calculates the similarity between the iris pattern of the first person and the iris pattern of the second person.

The evaluation value calculation unit 334 calculates the score of the first person based on the similarity calculated by the similarity calculation unit 233. The score of the first person is an example of the evaluation value depending on the similarity.

The registration unit 336 determines whether to register the information regarding the first person in the person dictionary 50 based on the evaluation value calculated by the evaluation value calculation unit 334. In a case where the evaluation value of the first person exceeds the threshold value, the registration unit 336 registers an image including the iris of the first person and/or the iris pattern as the information regarding the first person in the person dictionary 50.

Since in the configuration of the present third example embodiment, whether to register the first person in the person dictionary 50 is determined based on the cumulative value of the similarities, it is important that the similarity of the same person is large, and the similarity between different persons is small. In other words, it is necessary that identification accuracy of a person is high.

However, in a case where the identification accuracy of a person is not so high, there is no big difference in the similarity between any two persons, as in the example illustrated in FIG. 5. In such a case, it is favorable that the score calculation unit 337 sets a second threshold value and adds only a similarity larger than the second threshold value to the score. The second threshold is favorably larger than an average similarity between different persons and smaller than an average similarity of the same person. Thereby, the score calculation unit 337 does not add the similarity equal to or smaller than the threshold value to the score, and thus a similarity of a different person can be prevented from substantially affecting the score.

Meanwhile, in a case where there is a big difference between the average similarity of the same person and the average similarity between different persons (for example, the ratio of the two average similarities is 10:1 or 100:1), that is, in a case where the identification accuracy of a person is high, the score calculation unit 337 may not set the second threshold value. In such a case, even if the small similarity of another person is added to the score, the influence on the score is small.

In one modification, the score calculation unit 337 adds (plus) or subtracts (minus) the score of the first person who satisfies a predetermined condition. The predetermined condition is optional. For example, the score calculation unit 337 analyzes behavior, action, or attribute of the first person, and adds or subtracts the score of the first person according to an analysis result.

In this configuration, the person detection unit 20 tracks a person in the image captured by the camera 10, and transmits the time-series images including the same person to the image acquisition unit 231. The image acquisition unit 231 generates the face image including the region of the face of the second person from one of the time-series images received from the person detection unit 20. The feature extraction unit 232 extracts the feature of the face of the second person from the face image related to the second person generated by the image acquisition unit 231. The feature extraction unit 232 acquires the face image related to the first person registered in the temporary dictionary 235 and extracts the feature of the face of the first person.

The similarity calculation unit 233 calculates the similarity between the feature of the first person and the feature of the second person.

The score calculation unit 337 detects the behavior or action of the first person from the time-series images and evaluates the detected behavior or action of the first person by pattern matching. The score calculation unit 337 then adds or subtracts the score of the first person based on the evaluation result.

An example of the action of the first person includes that the person is talking with another person. In this case, the score calculation unit 337 adds the score. Another example of the action of the first person includes that the first person is acting in a hostile manner toward another person. In this case, a score calculation unit 337 subtracts the score.

According to the configuration of the present modification, the score of the first person is adjusted based on the behavior or action of the first person, whereby the first person can be easily registered or less easily registered in the person dictionary 50.

### Effects of Present Example Embodiments

According to the present example embodiment, the similarity calculation unit 233 as the similarity calculation means calculates the similarity between the first person and one or a plurality of the second persons. More specifically, the similarity calculation unit 233 calculates the similarity between the feature of the first person included in one image of the plurality of time-series images and the feature of the second person included in another image or a plurality of other images.

The evaluation value calculation unit 334 as the evaluation value calculation means includes the score calculation unit 337, and the score calculation unit 337 calculates the score that is the cumulative value of the similarities between the first person and the second person. The score is an example of the evaluation value.

The registration unit 336 as the registration means determines whether to register the information regarding the first person in the person dictionary 50 based on the score calculated by the score calculation unit 337. More specifically, in a case where the score of the first person has exceeded the threshold value, the registration unit 336 registers the face image of the first person in the person dictionary 50. The higher the score of the first person, the greater the likelihood that the first person has entered or left the facility many times before, and thus the greater the likelihood that the first person is not a suspicious person.

Thereby, the dictionary creation device 330 according to the present example embodiment can easily generate the person dictionary 50 without any labor of the administrator. A person who applies for registration does not need to perform an input operation like the technique described in PTL 1.

In addition, the dictionary creation device 330 according to the third example embodiment can discriminate a person to be registered in the dictionary (that is, a person permitted to enter the facility) and a person not to be registered in the dictionary (for example embodiment, a suspicious person) based on the score. Therefore, registration of all of persons in the person dictionary 50 without discrimination can be prevented, unlike the technique described in PTL 2.

### Fourth Example Embodiment

Another example embodiment of the present invention will be described below.

(Hardware Configuration)

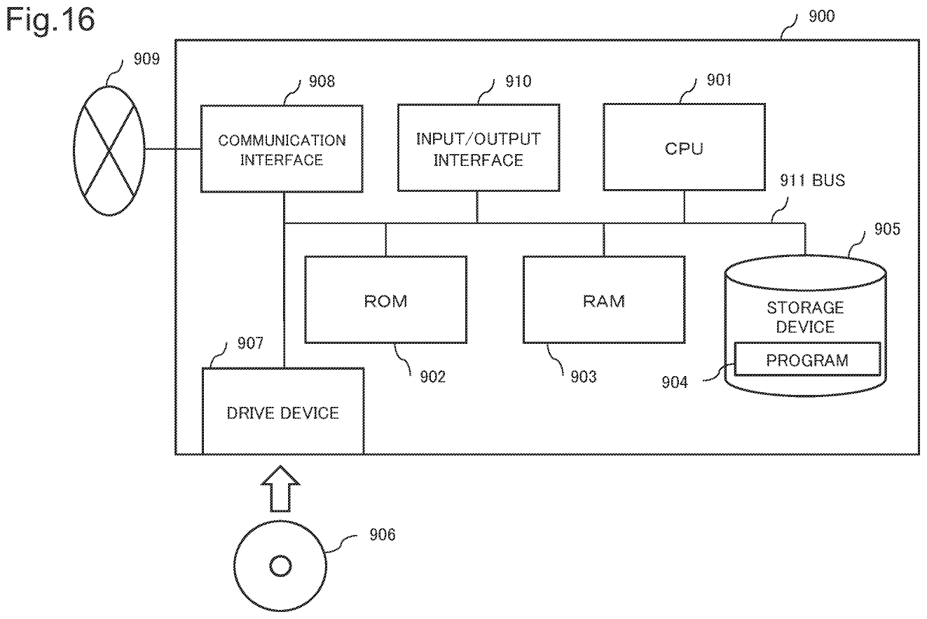

In each example embodiments of the present disclosure, the configuration elements of the devices represent blocks in functional units. Some or all of the configuration elements of the devices are implemented by any combination of an information processing device 900 as illustrated in FIG. 16 and a program, for example. FIG. 16 is a block diagram illustrating an example of a hardware configuration of the information processing device 900 that implements the configuration elements of the devices.

As illustrated in FIG. 16, the information processing device 900 includes, as an example, the following configurations:
a central processing unit (CPU) 901;
a read only memory (ROM) 902;
a random access memory (RAM) 903;
a program 904 loaded to the RAM 903;
a storage device 905 that stores the program 904;
a drive device 907 that reads/writes data from/to a recording medium 906;
a communication interface 908 connected to a communication network 909;
an input/output interface 910 that inputs/outputs data; and
a bus 911 connecting the configuration elements.

The configuration elements of the devices in each example embodiment are implemented by the CPU 901 acquiring and executing the program 904 for implementing the functions of the configuration elements. The program 904 for implementing the functions of the configuration elements of the devices is stored in advance in the storage device 905 or the ROM 902, for example, and is loaded to the RAM 903 and executed by the CPU 901 as necessary. The program 904 may be supplied to the CPU 901 through the communication network 909 or may be stored in the recording medium 906 in advance and the drive device 907 may read and supply the program to the CPU 901.

### Effects of Present Example Embodiments

According to the configurations of the present example embodiments, the device described in any of the above example embodiments is implemented as hardware. Therefore, similar effects to the effects described in any of the example embodiments can be exhibited.

While the present invention has been particularly shown and described with reference to the example embodiments thereof, the present invention is not limited to these example embodiments. It will be understood by those of ordinary skill in the art that various changes in form and details may be made therein without departing from the spirit and scope of the present invention as defined by the claims.

### Application Example

In the above description, the monitoring of a person has been used as an example. However, an application example of the present invention is not limited to the example. For example, the present invention can be used to detect regular customers in a store. The monitoring system according to the present application example stores, in a person dictionary, the number of times a customer has visited the store in association with the face image of the customer. Thus, for example, the store can provide the customer with a special service according to the number of times the customer has visited the store.

[Supplementary Note]

Some or all of the above-described example embodiments can be described as supplementary notes below but are not limited to the configurations described in the following supplementary notes.

(Supplementary Note 1)

A dictionary creation device including:

an image acquisition means for acquiring a plurality of images captured at intervals within a predetermined area;

a feature extraction means for extracting a feature of a person included in each of the plurality of images;

a similarity calculation means for calculating a similarity between the feature of a first person included in one image of the plurality of images and the feature of a second person included in another image or a plurality of other images; and

a registration means for determining whether to register information regarding the first person in a dictionary based on the similarity.

(Supplementary Note 2)

The dictionary creation device according to the supplementary note 1, in which

the registration means registers the information regarding the first person in the dictionary in a case where the similarity exceeds a threshold value.

(Supplementary Note 3)

The dictionary creation device according to the supplementary note 1 or 2, further including:

an evaluation value calculation means for calculating an evaluation value that changes depending on the similarity, in which

the registration means determines whether to register the information regarding the first person in the dictionary based on the evaluation value.

(Supplementary Note 4)

The dictionary creation device according to the supplementary note 3, in which

the evaluation value calculation means includes

a same person determination means for determining whether the first person and the second person are same based on the similarity, and

a count calculation means for calculating the number of times that the first person and the second person are determined to be the same, as the evaluation value.

(Supplementary Note 5)

The dictionary creation device according to the supplementary note 3, in which

the evaluation value is a cumulative value obtained by summing the similarity.

(Supplementary Note 6)

The dictionary creation device according to any one of the supplementary notes 1 to 5, in which

the feature extraction means extracts a feature of a face of a person included in each of the plurality of images, and

the similarity calculation means calculates the similarity between the feature of the face of the first person and the feature of the face of the second person.

(Supplementary Note 7)

A biometrics device including:

an input means for acquiring an input image;

a collation means for collating a person in the input image with the first person registered in the dictionary generated by the dictionary creation device according to any one of the supplementary notes 1 to 6 by referring to the dictionary; and

an output means for outputting a collation result by the collation means.

(Supplementary Note 8)

A dictionary creation method including:

acquiring a plurality of images captured at intervals within a predetermined area;

extracting a feature of a person included in each of the plurality of images;

calculating a similarity between the feature of a first person included in one image of the plurality of images and the feature of a second person included in another image or a plurality of other images; and

determining whether to register information regarding the first person in a dictionary based on the similarity.

(Supplementary Note 9)

The dictionary creation method according to the supplementary note 8, further including:

calculating an evaluation value that changes depending on the similarity, in which

the determining whether to register information regarding the first person in a dictionary based on the similarity is determining whether to register information regarding the first person in the dictionary based on the evaluation value.

(Supplementary Note 10)

A non-transitory recording medium storing a program for causing a computer to execute:

acquiring a plurality of images captured at intervals within a predetermined area;

extracting a feature of a person included in each of the plurality of images;

calculating a similarity between the feature of a first person included in one image of the plurality of images and the feature of a second person included in another image or a plurality of other images; and

determining whether to register information regarding the first person in a dictionary based on the similarity.

(Supplementary Note 11)

The recording medium according to the supplementary note 10, in which

the program causes the computer to further execute

calculating an evaluation value that changes depending on the similarity, and

the determining whether to register information regarding the first person in a dictionary based on the similarity is determining whether to register information regarding the first person in the dictionary based on the evaluation value.

(Supplementary Note 12)

A monitoring system including:

a person detection means;

a dictionary creation device; and

a biometrics device, in which

the person detection means detects a region of a person from a plurality of images captured at intervals within a predetermined area,

the dictionary creation device includes

an image acquisition means for acquiring the plurality of images including the region of the person from the person detection means,

a feature extraction means for extracting a feature of the person included in each of the plurality of images,

a similarity calculation means for calculating a similarity between the feature of a first person included in one image of the plurality of images and the feature of a second person included in another image or a plurality of other images, and

a registration means for determining whether to register information regarding the first person in a dictionary based on the similarity, and

the biometrics device includes

a collation means for collating a person in the input image with the first person registered in the dictionary by referring to the dictionary generated by the dictionary creation device, and

an output means for outputting a collation result by the collation means.

### INDUSTRIAL APPLICABILITY

The present invention can be used in, for example, a monitoring system to which a biometrics technology is applied. Furthermore, the present invention can also be used in stores for customer management.

### REFERENCE SIGNS LIST

1 monitoring system
10 camera
20 person detection unit
30 dictionary creation device
31 image acquisition unit
32 feature extraction unit
33 similarity calculation unit
34 registration unit
40 biometrics device
41 input unit
42 collation unit
43 output unit
50 person dictionary
60 notification unit
230 dictionary creation device
231 image acquisition unit
232 feature extraction unit
233 similarity calculation unit
234 evaluation value calculation unit
237 registration unit
238 same person determination unit
239 count calculation unit
330 dictionary creation device
334 evaluation value calculation unit
336 registration unit
337 score calculation unit

What is claimed is:

1. A dictionary creation device comprising:
a memory storing instructions; and
at least one processor configured to execute the instructions to perform:
acquiring a plurality of images captured at intervals within a predetermined area;
extracting a feature of a person included in each of the plurality of images;
calculating a similarity between the feature of a first person included in one image of the plurality of images and the feature of a second person included in another image or a plurality of other images; and
determining whether to register information regarding the first person in a dictionary based on the similarity.

2. The dictionary creation device according to claim 1, wherein
the at least one processor is configured to execute the instructions to perform:
registering the information regarding the first person in the dictionary in a case where the similarity exceeds a threshold value.

3. The dictionary creation device according to claim 1, wherein:
the at least one processor is further configured to execute the instructions to perform:
calculating an evaluation value that changes depending on the similarity, and
determining whether to register the information regarding the first person in the dictionary based on the evaluation value.

4. The dictionary creation device according to claim 3, wherein
the at least one processor is configured to execute the instructions to perform:
determining whether the first person and the second person are same based on the similarity, and
calculating the number of times that the first person and the second person are determined to be the same, as the evaluation value.

5. The dictionary creation device according to claim 3, wherein
the evaluation value is a cumulative value obtained by summing the similarity.

6. The dictionary creation device according to claim 1, wherein
the at least one processor is configured to execute the instructions to perform:
extracting a feature of a face of a person included in each of the plurality of images, and
calculating the similarity between the feature of the face of the first person and the feature of the face of the second person.

7. (canceled)

8. A dictionary creation method comprising:
acquiring a plurality of images captured at intervals within a predetermined area;
extracting a feature of a person included in each of the plurality of images;
calculating a similarity between the feature of a first person included in one image of the plurality of images and the feature of a second person included in another image or a plurality of other images; and
determining whether to register information regarding the first person in a dictionary based on the similarity.

9. The dictionary creation method according to claim 8, further comprising:
calculating an evaluation value that changes depending on the similarity, wherein
the determining whether to register information regarding the first person in a dictionary based on the similarity is determining whether to register information regarding the first person in the dictionary based on the evaluation value.

10. A non-transitory recording medium storing a program for causing a computer to execute:
acquiring a plurality of images captured at intervals within a predetermined area;
extracting a feature of a person included in each of the plurality of images;
calculating a similarity between the feature of a first person included in one image of the plurality of images and the feature of a second person included in another image or a plurality of other images; and
determining whether to register information regarding the first person in a dictionary based on the similarity.

11. The recording medium according to claim 10, wherein
the program causes the computer to further execute
calculating an evaluation value that changes depending on the similarity, and
the determining whether to register information regarding the first person in a dictionary based on the similarity is determining whether to register information regarding the first person in the dictionary based on the evaluation value.

12. (canceled)
